(19) United States
(12) Patent Application Publication
(10) Pub. No.: US 2016/0178418 A1
(43) Pub. Date: Jun. 23, 2016

(54) STROKE VOLUME DISPLACEMENT FLOW RATE SENSOR AND METHOD FOR REGULATING FLOW

(71) Applicant: FLUONIC INC., Boulder, CO (US)

(72) Inventors: Amir Genosar, Boulder, CO (US); Seth Miller, Boulder, CO (US)

(21) Appl. No.: 14/907,740

(22) PCT Filed: Jul. 29, 2014
(86) PCT No.: PCT/US14/48601

§ 371 Date: Jan. 26, 2016

(51) Int. Cl. G01F 1/58

(52) U.S. Cl. CPC G01F 1/584

(57) ABSTRACT

A flow rate sensor comprising a body comprising an inlet and an outlet and a flight-tube interconnecting there between. A plurality of electrodes are disposed along the flight tube. The electrodes are electrically operable to introduce a marker to the fluid at a first position in the form of a local fluid composition variation and to detect the position of the marker at least at a second position downstream of the first position, thereby determining the displacement of a fluid volume in the flight-tube and infer the volumetric flow rate of the fluid at a flow pulse.

### FIELD

This disclosure relates to the art of flow rate measurement and control. More specifically, this disclosure relates to a novel method for measuring and regulating minute flow pulses.

### BACKGROUND

It is a considerable technical challenge to achieve highly accurate measurement of low flow rates. An example of a sensor that has met this challenge is a compositional time of flight sensor. In this class of sensor, the fluid flows through a passageway or a “flight tube” and at least two pair of electrodes are disposed across the flight tube: a first ‘write’ pair of electrodes at an upstream portion of the flight tube, and a second pair of ‘read’ electrodes downstream from the write electrodes. Electric current is driven through the write electrodes and the conductive fluid in its vicinity to apply a ‘write’ pulse by performing a small amount of oxidation and reduction on the fluid, and this slightly changes the fluid's conductivity locally above the redox electrodes. This “marker” of altered conductivity flows downstream from the write electrodes towards the second pair of “read” electrodes, which senses its arrival by measuring a change in the conductivity or capacitance of the fluid. The flow rate of the marker is calculated based on the time of flight of the marker between write and read electrodes, and the known volume of the channel between the write and read electrodes.

While this technique is excellent for measuring continuous flows, it is challenged when measuring discontinuous flow such as pulsatile flow. In a pulsatile system, flow will occur at a high rate for a first time period (termed the “stroke”). After the stroke is complete the system will sit idle for a second time period (termed the “delay”). The fraction of time the system spends in stroke is termed the “duty cycle”, and this is calculated by Equation 1:

duty cycle=(stroke time)/((stroke time)+(delay time)). (1)

In a compositional time of flight sensor, if the volume of the stroke is smaller than the volume of the flight tube (between the write and read electrodes), a marker that is created in the flow may not reach the read electrode during the stroke. Additionally, even when the stroke volume is larger than the volume of the flight tube, if the timing of the stroke is not properly synchronized with the write pulse, some or all of the information of the total stroke volume may be missed, resulting in significant volumetric flow rate measurement inaccuracies. If this is the case, it is not possible to perform a flow measurement to measure the rate of flow during the stroke. If the delay is brief and another stroke immediately follows it, the marker will be transported to the read electrodes relatively quickly, and an average flow rate will be determined over the time of flight between the write and read. This average flow rate will not correspond to the average flow of the system if the stroke and delay periods do not line up exactly with the time of flight period. While it is possible to improve the accuracy of the measurement of the average flow rate by averaging the flow rate measurements associated with many write pulses over time, for very low duty cycles this average will be noisy and may take an impractically long time to converge on an accurate value. In such a situation, the ability of the system to alert the user if flow range is outside a target value is compromised.

This situation is compounded in applications where the delay times are very long, such that the marker has the opportunity to degrade considerably between strokes. In this situation, the signal of the marker at the read electrode is weakened and may disappear entirely if the delay time is long enough, destroying the ability of the flow sensor to measure flow rates.

The conventional compositional time of flight flow sensor is further compromised in that it is unable to measure the true stroke volume. Such information may be helpful, for example, in diagnosing the performance of a mechanical pump. However, because a conventional compositional time of flight sensor can only measure average flow over the time of flight, this information is lost.

Thus, improved systems for measuring low pulsatile flows and the volume of individual pump strokes are desired.

### SUMMARY

Described herein is a flow sensor and system capable of measuring the volume of individual strokes of flow in a fluid passageway, and methods for computing stroke volume and total flow rate from the sensor data. Methods for calculating pulsatile flow rates by summing these volume measurements over time are also described. Methods for operating the sensor in synchronization with the flow source to optimize volumetric flow measurement are also described. Flow sensors comprising a combination of flow measurement techniques are also described.

In some embodiments, a flow sensor comprises a body comprising an inlet port and an outlet port and a flight tube interconnecting there between. A plurality of electrodes are disposed in the flight tube. In some arrangements, the electrodes are disposed on at least one wall of the flight tube, across the general direction of the flight tube.

In some arrangements, the electrodes are arranged in pairs, with the pairs defined such that two electrodes are physically closer to each other than to their nearest neighbors. In some arrangements, these pairs are disposed so that that they are equidistant from each other along the length of the channel. In other arrangements, these pairs are more densely arranged near the input of the channel, and less densely arranged near the output of the channel. In some embodiments, the pairs of electrodes are defined by their electric operation rather than by physical arrangement.

In some embodiments, the electrodes are arranged like a comb with same or difference distance between the electrodes. At least one pair of electrodes, preferably ones that are proximal to each other, serve as a write electrode and ground, respectively, and are used to introduce a marker to the fluid in the flight tube by locally changing the composition of the fluid, in the same mechanism described in U.S. Pat. Nos. 6,675,660; 7,225,683; 7,703,336; and 8,347,731, incorporated herein by reference. The write function may switch from one set of electrodes to another set of electrodes along the operation of the sensor. At least one electrode serves as a read electrode and is used to detect a variation in the composition of the fluid in the flight tube in the same mechanism described in U.S. Pat. Nos. 7,225,683 and 6,675,660, incorporated herein by reference. The read function may be read in parallel from all the various read electrodes simultaneously, or may switch from one or a set of electrodes to another one or set of electrodes along the operation of the sensor. In some embodiments, the write electrodes create a local change in pH by performing electrolysis of water in the flow, and the read electrodes sense current in the read electrode due to a change in the capacitance created on the electrode as the pH of the fluid that flies by the electrode changes, due to a double layer capacitor effect created on the electrode.

A processor receives the data from the read electrodes and compiles the position of the market. The stroke volume is calculated from the known cross section of the flight tube, the position of the marker prior to the stroke, and the new position of the marker. At a given stroke a marker may be traveling from a first position at the write electrodes toward a second downstream position by a first read electrode or set of read electrodes, or it may travel from said second position to a third position by a second read electrode or set of read electrodes, and so on. As long as the marker has not left the flight tube and the system determines it has not dissipated to be too small for determining its position, said same marker can be continued to use to determine the progression of the fluid in the flight tube. In some arrangements, the function of read and write electrodes can be switched. For example, a pair of write electrodes can be used as read electrodes after introducing a marker.

The definition of upstream and downstream position as used herein is defined by the direction of the flow, hence downstream read electrodes according to a first flow direction can be switched to perform as write electrodes when the direction of the flow changes.

In some embodiments, there are greater than six individual electrodes in the channel. In some embodiments, there are greater than or equal to sixteen individual electrodes in the channel. In some embodiments, there are greater than or equal to thirty two individual electrodes in the channel. In some embodiments, these thirty two individual electrodes define sixteen electrode pairs. In some embodiments, these thirty two individual electrodes define thirty two read electrodes.

According to some embodiments described herein, the stroke volume measurement system comprises a sensor, electronics for applying the write pulse to the write electrode, and electronics for reading an analog signal from the read electrodes. In some embodiments, the electronics are in communication with the flow control mechanism itself, so that a write pulse is applied to the fluid at a defined time before the flow stroke is initiated. The flow control mechanism may be one or a combination of at least a pump, a valve, a flow regulator, a pressure regulator, and a connector. In some embodiments, the time between the write pulse and the beginning of the stroke is less than 100 ms. In some embodiments, the time is less than 10 ms.

The applicants have demonstrated that in the laminar flow regime that exists in the flight tube, a good detection of the marker can be obtained more than 20 seconds after the write event. Hence in some embodiments, the time between the write pulse and the beginning of the stroke is one second, or five seconds, or 20 seconds or more. During this long time period, the marker spreads along the axis of the flow tube due to molecular diffusion, and as a result, in some embodiments the read electrodes are arranged so that the marker will opportunistically overlap multiple read electrodes simultaneously, which can enable more accurate measurement of marker volume with fewer electrodes, as will be discussed below.

According to some embodiments described herein, stroke volume is calculated based upon the distance the marker travels during the stroke time period. In some embodiments, the stroke time period is defined by information provided external to the sensor, for example by a communication system from the pump electronics that control the stroke, or by a pressure sensor. In some embodiments, a differential pressure sensor detects a pressure differential between the upstream of the flight tube and the downstream of the flight tube, and activates a write pulse as soon as pressure difference is detected. In some embodiments, the stroke time period is defined by flow rate measurement by at least a plurality of read electrodes or electrode pairs. In this arrangement, the beginning of the stroke time period may be determined based on a signal identified at a first read electrode pair which is used to calculate a first flow rate, and the end of the stroke time period is defined based on a calculation of when the stroke flow rate approaches zero. In some arrangements, the time at which the flow rate approaches zero is defined as the time at which the rate of advancement of the marker through the channel falls below a threshold value compared with the initially measured flow rate. For example, when the system computes that the flow rate is at least <10% of the initial flow rate, it defines this flow rate as having approached “zero” and defines the stroke time period and stroke volume accordingly.

According to some embodiments, the distance the marker travels is defined as the distance to the furthest electrode or electrode pair that has sensed the peak of the marker during the stroke time period. In some embodiments, this distance is further refined by calculating how far the marker has traveled in between two electrodes or electrode pairs. Because the marker has some dispersion associated with its slow diffusion away from the marked zone over time, the read signal at a read electrode pair may be greater than zero even if the peak of the marker has already passed by the electrode pair, or not arrived at it yet. Using the detail of this read signal, it is possible to measure the onset of the arrival of the marker, and further measure the departure of the marker over time as it passes by the read electrode pair. In some embodiments, the sensor system of this invention measures this peak shape information and computes the position of the marker peak based on the measured shape, and thereby further refines the final position of the marker. In some arrangements, the marker will be broad enough to overlap with more than one electrode at a given time, so that the peak position of the marker may be calculated by consideration of the peak shape at more than one electrode. In some arrangements, a no-flow condition is detected by measurement of the read electrodes both upstream and downstream of the current marker position. By measuring the change in signal at read electrodes upstream and/or downstream of the marker peak, it is possible to separately compute the diffusion rate and the flow rate of the marker. If the flow rate is established to be below a set threshold, a no-flow condition is established. In some arrangements, information about no-flow conditions may trigger an alert to the user to notify about the potential for occluded flow. In some arrangements, the no-flow condition is determined from at least the detection of a stagnant position of the marker by a first electrode or set of electrodes, the diffusion of the marker to a second electrode or set of electrodes downstream of the first set of electrodes, the diffusion of the marker to a third electrode or set of electrodes upstream from the first set of electrodes, and/or the absence of the marker at either the second set or the third set of electrodes.

By measuring the time it takes for a marker to expand away from the center point it becomes possible to compute the diffusivity of the marker (e.g., H+) in the fluid, and thereby calculate the viscosity of the fluid using the Stokes-Einstein equation. This measured value of viscosity can be further used in calculations of time of flight for fast-moving fluids, where the rate of flow at the center of the channel may differ from the rate of flow at the wall of the channel where the marker is measured, and where this difference depends on the viscosity of the fluid. Thus, in some embodiments, the flow rate of the fluid is calculated based on the time of flight, the known volume of fluid between the write electrodes and the read electrode, and the viscosity of the fluid.

According to some embodiments, the distance traveled by the marker is computed into a volume based on the known channel (i.e., flight tube) cross section dimensions, and the known distances of each read electrode or electrode pair from the write electrode pair.

According to some embodiments, more than one write pulse is applied during a stroke. In some arrangements, the time between write pulses is less than the time required for a marker to transit from the first to the last read electrode at the flow rate of the fluid. In some arrangements, the sensor system computes a time between write pulses based on measurement of the flow rate. In some embodiments, a single marker itself is formed from more than one write pulse. In such embodiments, the write pulses are very close to each other in time so that the markers created by each individual write pulse effectively overlap. In this way, a marker with a greater breadth in space may be created, and this may be helpful in allowing the marker to overlap with multiple read electrodes at once.

According some embodiments, a stroke volume measurement is made by a marker that exists in the flow channel at the time of the stroke. In one example, a marker is created in the flow prior to a first stroke, and the volume of this first stroke is calculated by measuring the first position of the marker at the end of the stroke, according to one of the methods disclosed herein. A second stroke is performed, and the volume of this second stroke is measured by measuring the distance moved by the marker from the first position to a new, second position. In such embodiments, a third stroke may be performed and its volume calculated by measuring the distance traveled by the marker from a second position to a third position. In this way, it is possible to measure the volume of two or more strokes using a single marker.

According to some embodiments, a marker is formed upstream of the flight tube.

According to some embodiments, the total volume passed through the sensor is calculated based on flow volume measurements, flow rate measurements, and/or combinations thereof. The sensor may combine prior art composition-variation time-of-flight flow measurement with stroke volume displacement measurement of the present disclosure. In some arrangements, at least one of the electrodes in the flight tube is operable for the time-of-flight measurement and the stroke volume displacement measurement. In some arrangements a write electrode pair is common to a time-of-flight sensor and the stroke volume displacement sensor. In one arrangement a set of read electrodes is common to a time-of-flight flow sensor and a stroke volume displacement sensor. In some arrangements, the same marker is utilized to do both time-of-flight flow measurement and a stroke volume displacement measurement. In some arrangements, the system determines which flow measurement information to use based on the nature of the flow. In some arrangements, a combination of time-of-flight measurement and stroke volume displacement measurement is used to improve time-of-flight flow measurement accuracy. Time-of-flight measures average flow rate during the travel time period of a marker from the write electrodes to the read electrodes, but can't measure variations in the flow rate during that period, or predict flow variations between measurements. The stroke volume displacement measurement detects variations in the flow over a time-of-flight flow measurement cycle and hence can help construct a flow rate profile between time-of-flight measurement cycles.

In some arrangements, a flow sensor comprises more than one flight tube in parallel. In some arrangements, the dimension of a first flight tube is different of the dimensions of a parallel second flight tube. In some arrangements, the measured displacement of a marker in a first flight tube and the displacement of the marker in a parallel second flight tube are utilized to compute the fluid viscosity.

In some arrangements, the volumetric flow rate information is utilized to adjust the operation of a flow control mechanism. In some arrangements, integration of the measured flow rate over time, i.e., the pass-through fluid volume over a given time period, is utilized to adjust the operation of the flow control mechanism. In some arrangements, a combination of the actual measure flow rate and the integration of the measured flow rate over time is utilized to adjust the operation of the flow control mechanism.

In some arrangements, the flow sensor is combined with a normally closed valve operable for momentarily opening in response to a processor command, allowing a volume of fluid to pass by. In some arrangements, the volume of fluid allowed to pass by actuation of the valve is smaller than the sensor flight tube volume such that the displacement of a single marker can be captured by the read electrodes and determine the total volume displaced during a single momentary opening of the valve. In this way a processor or processors controlling the flow rate can use the sensor information to adjust the schedule for subsequent openings of the valve.

In some arrangements, the flow control mechanism comprises at least one normally closed check valve, disposed between a drug reservoir and an injection site to the patient. Continuous pressure maybe formed upstream of the check valve by one of the means known in the art including gravity, elastomeric pump, mechanical or electronic pump, but the valve opening threshold pressure is set higher than said continuous upstream pressure. A force is applied to the fluid to creating a momentary pressure greater than said threshold pressure upstream of the valve, allowing a volume of fluid (the stroke volume) to pass through the valve. The momentary pressure can be created by any means known in the art including, but not limited to: (a) operating a piezoelectric resonator to create a pressure wave in the fluid, (b) operating an electromagnetic vibrator to create pressure wave in the fluid, (c) operating other type of vibrators to create pressure wave in the fluid, (d) operating a magnetostrictive transducer to create pressure wave in the fluid, (e) operating an electrical or electromagnetic acoustic transducer to create pressure waves in the fluid, (f) other means known in the art, or (g) any combination of the above.

In some arrangements, the threshold opening pressure of the check valve is momentarily reduced by one of (a) changing the magnetic field around the check valve, (b) changing the electric field around the check valve, (c) changing the temperature of at least a portion of the valve and relaxing its biasing force, (d) other means known in the art, and (e) any combination of the above. The stroke volume that passed the valve is determined by the stroke volume displacement flow sensor, and this information is used to determine the schedule for the next valve opening cycle or cycles to meet a desired flow rate, or a total volume delivered or a combination of those.

The valve may be generally constructed to include at least one of (a) a spring loaded ball biased toward a conical sealing lip (a ball check valve), (b) a diaphragm check valve, (c) a mitral valve, (d) a permeable or semipermeable membrane, (e) other check valves known in the art, or (f) any combination of the above. A permeable or semipermeable membrane may be useful to significantly restrict the flow of the fluid to a degree beyond which is typically achieved using a conventional flow restrictor such as a microchannel. The flow rate through the semipermeable electrode is exponentially dependent on temperature, and the permeability may be raised/lowered considerably by raising/lowering the membrane itself (along with the local temperature of the fluid). The flow rate through the permeable membrane may be variable, such as the variable permeability membrane disclosed in U.S. Pat. No. 4,513,034 and in related work.

In some embodiments, a check valve is disposed in the line in reverse position to the one described above where it can't open due to upstream pressure. The valve construction may be one of several known in the art such as check valve and diaphragm valve. The valve is manipulated to momentarily open by one of the means known in the art including, but not limited to, (a) change in an electric field, (b) change in a magnetic field, (c) directly applying a mechanical force to valve for example through a rod or a cam, (d) by manipulating a bi-metal component, (e) by manipulating a shape memory alloy, (f) other techniques known in the art, and (g) any combination of the above.

In some embodiments, a flow control system comprises a first flight tube comprising a first sensor and a first flow control mechanism, and a parallel second flight tube comprising a second flow sensor and a second flow control mechanism. In some embodiments, said parallel second flight tube is configured to drive higher flow than the first flight tube. In some embodiments, the sensor comprises multiple flight tubes and a valve system for adjusting, allowing, or preventing flow in at least one of these flight tubes

According to some embodiments, the marker may be a heat marker, a color mark, or any other type of mark that can be formed by a marker generator in an upstream position and detected by at least one sensor downstream of the marker generator. In some embodiments, the marker is a heat mark, the marker generator produces a laser beam that locally heats the fluid to create this marker, and the marker detectors are temperature sensors.

### BRIEF DESCRIPTION OF THE FIGURES

FIGS. 1a and 1b illustrates a construction of a prior art time-of-flight flow sensor;

FIGS. 2a and 2b illustrates a preferred arrangement of a stroke volume displacement sensor of the present disclosure;

FIG. 3 illustrates a flow sensor combined with a first flow control system comprising a ball check valve;

FIG. 4 illustrates a flow sensor combined with a second flow control system;

FIGS. 5a and 5b illustrate a flow sensor combined with a flow control system comprising a diaphragm;

FIGS. 6a and 6b illustrate a flow sensor combined with a flow control system comprising a leaf spring check valve;

FIG. 7 illustrates a flow control device with multiple outlet valves;

FIG. 8 illustrates a drug delivery device;

FIG. 9 illustrates a channel with a single pair of electrodes designated as the write electrodes and 16 pairs designated as read electrodes;

FIG. 10 illustrates a channel with a single electrode designated as the write electrode and 16 single electrodes designated as read electrodes;

FIG. 11 illustrates the readings from a 16 electrode sensor 100 ms after marker formation at a flow rate of 20 μL/min;

FIG. 12 illustrates the readings from a 16 electrode sensor 200 ms after marker formation at a flow rate of 20 μL/min;

FIG. 13 illustrates the readings from a 16 electrode sensor 100 ms after marker formation at a flow rate of 20 μL/min;

FIG. 14 illustrates the readings from a 16 electrode sensor 1200 ms after marker formation at a flow rate of 5 μL/min;

FIG. 15 illustrates top, side, and front views of a conventionally produced microsensor;

FIG. 16 illustrates a rotated sensor geometry where input and output ports are in the same axis as the channel;

FIG. 17 illustrates a vertical sensor geometry where the channel runs through the thickness of the substrate;

FIG. 18 illustrates an example method of manufacturing the channels of this invention using a semiconductor fabrication process;

FIG. 19 illustrates an example method of manufacturing the channels of this invention using a polymer fabrication process;

FIG. 20 illustrates a flow sensor containing multiple parallel channels;

FIG. 21 illustrates an example method of manufacturing the channels of this invention using a wafer bonding process;

FIG. 22 illustrates an example method of manufacturing the channels of this invention using a second wafer bonding process;

FIG. 23 illustrates an example method of manufacturing a sensor where the electrode layer is patterned during the manufacturing process; and

FIG. 24 illustrates an example sensor with a non-uniform channel shape and electrode placement.

### DETAILED DESCRIPTION OF THE DRAWINGS

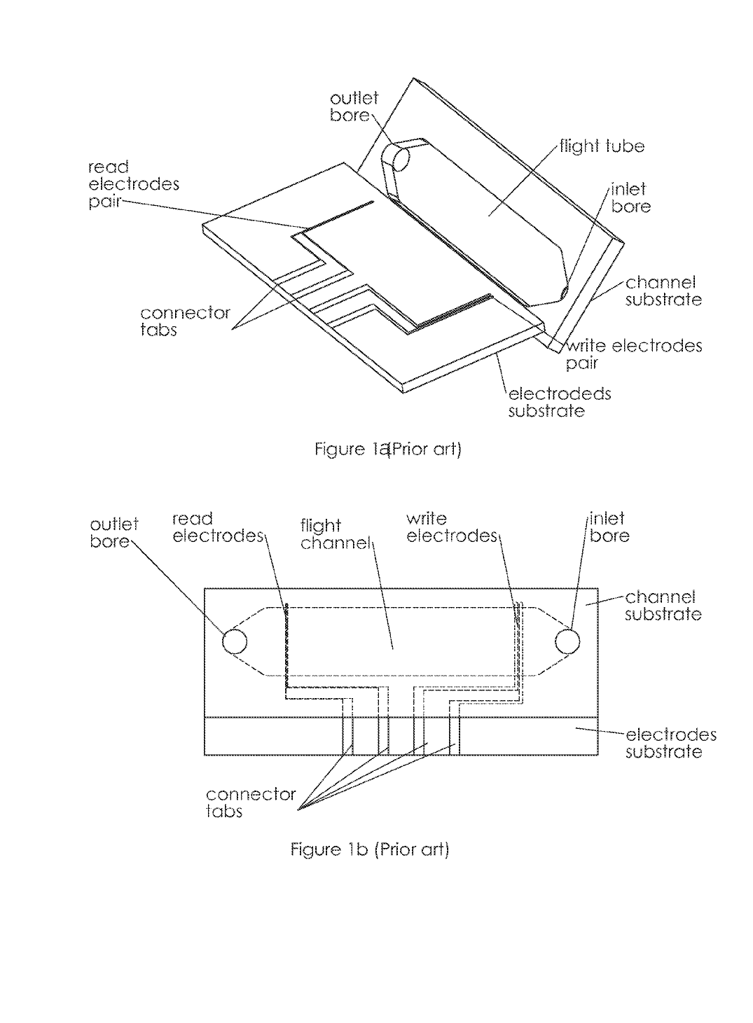

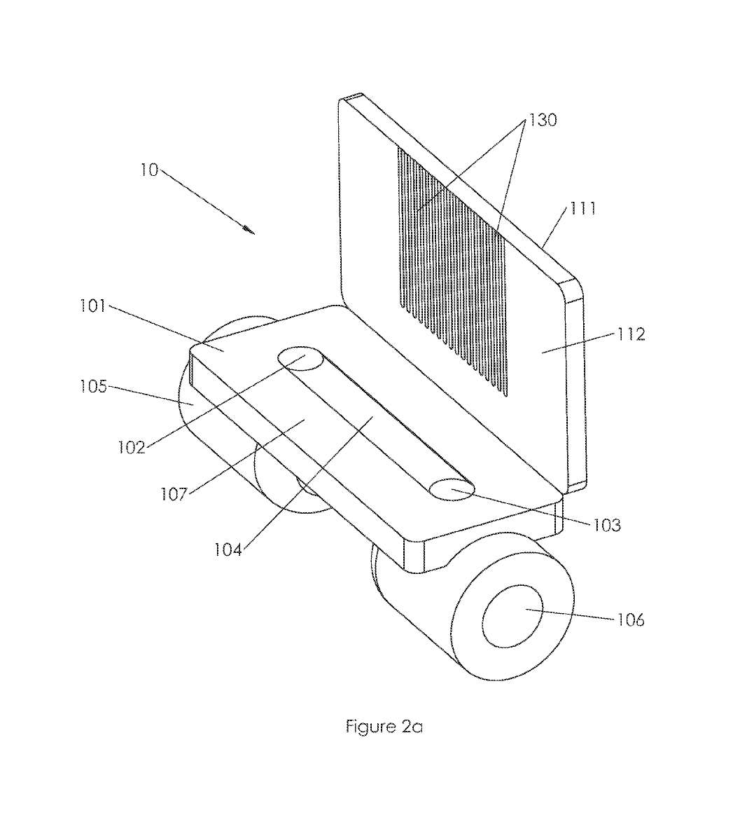

FIGS. 1a and 1b illustrate a time-of-flight flow sensor configuration according the invention disclosed in U.S. Pat. Nos. 7,225,683 and 6,675,660. FIG. 1a shows an exploded view where the channel substrate is rotated and moved away from the electrodes substrate, and FIG. 1b shows a top assembled view of the sensor. The sensor comprises a channel substrate comprising an inlet bore and an outlet bore, and a recessed channel communicating there between. The sensor further comprises electrodes substrate comprising electrode pattern disposed at its surface. The electrode substrate and the channel substrate are joined in a sealed-tight fashion to form a closed flight tube (flight channel) between the inlet and the outlet, with the electrodes exposed on one of the walls of the flight tube. The electrodes are leading to the edge of the electrode substrate, and the channel substrate is slightly recessed to form connector tabs. The electrodes form read electrodes or a pair of read electrodes and a pair of write electrodes. The write electrodes are used to electrically form a local composition variation marker in the fluid. The marker advances downstream with the flow and is detected by the read electrodes and the flow rate is analyzed from the ‘time of flight’ of the marker between the well-defined positions of the write and read electrodes and the flight-tube cross-section size. This flow measurement principle has been shown to be very precise in continuous flows. However at interrupted flows, or pulsatile flow, or stroked flow important information can be missed by this sensor for example when: (a) the flow during the time-of-flight measurement interval is substantially different than the flow rate between measurement intervals, and where (b) the volume of flow moved in the channel at each flow interval is smaller than the volume of the channel such that the marker doesn't reach the read electrodes.

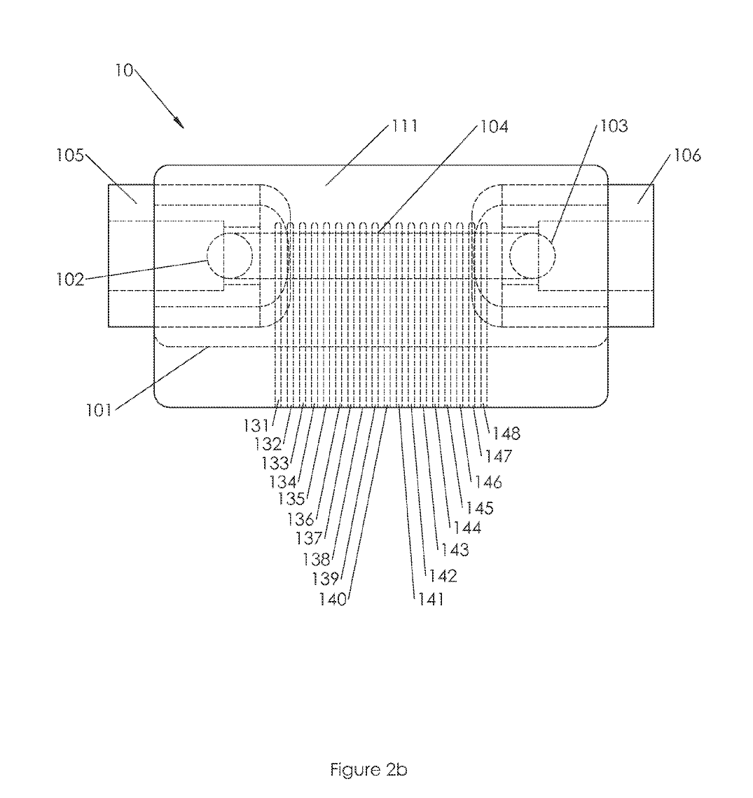

FIGS. 2a and 2b illustrate one arrangement of the stroke volume displacement flow sensor 10 of the present invention. FIG. 2a illustrates the sensor 10 in an exploded view where the electrodes substrate 111 is removed and rotated from the channel substrate 101. The channel substrate comprises an inlet port 105 leading to inlet bore 102, and an outlet bore 103 leading to an outlet port 106; and a recessed channel 104 disposed on its channel surface 107 and interconnecting between the inlet bore 102 and the outlet bore 103. The ports 105 and 106 are configured to join to a tube. In one arrangement the channel substrate is injection molded from Polycarbonate and the ports 105, 106 are joined to PVC tubing via adhesion bonding. In other arrangements the ports may have another configuration known in the art including a male or female Luer, and barb connector. Electrodes 130 are disposed on the electrodes surface 112 of the electrodes substrate 111. The electrodes surface 112 is joined with the channel surface 107 in a fluid tight fashion to form a closed flight tube, with the electrodes 130 having one end reaching into the flight tube, and the second end providing exposed connectors to the processor and electric circuitry. The structure of this sensor 10 can perform time-of-flight flow measurement by operating at least a first set of electrodes as the right electrodes, for instance electrodes 133 and 134; and at least one second electrode or set of electrodes as the read electrodes for instance, electrode 141 and electrode 147, or electrodes 141, 142 and electrodes 147,148. The sensor can further sense diffusion of a marker by detecting the spread of the marker. In one scenario the fluid in the flight tube 104 is stagnated and at a first time point the marker is sensed by a first read electrode or set of read electrodes, for instance by electrode 140 or electrodes couple 140, 141, but not by electrode 139 or electrodes couple 139, 140. At a second time point the marker is sensed by electrode 139 or electrodes pair 139,140 and electrode 141 or electrodes pair 141, 142 which allows analyzing the diffusion of the marker as well as detect minute displacements of the marker in the flight tube 104. Any electrode or set of electrodes 130 can be used as read electrodes and allow the processor to determine the exact position and displacement of the marker at any given time. The flow rate is analyzed from the displacement of the marker and the cross section of the flight tube. More than one marker can be traced at a given time, and preferably there's at least one marker present at the flight tube 104 when the fluid is moving. For pulsating flow the fluid volume of a flow stroke can be analyzed from the displacement of the marker from a first rest position to a second rest position, or the displacement of more than one marker during that period.

More generally, FIGS. 2a and 2b illustrate a sensor 10 for measuring volumetric flow rate of a fluid, comprising a body (at least one of 101 and 111) comprising an inlet 105 and an outlet 106 and at least one flight tube 104 there between comprising at least one marker detector 130 disposed along said flight tube 104 configured to detect a position of at least one marker in the fluid; and a control circuitry for determining the volumetric displacement of the fluid along the flight tube from a first known position of said marker, and at least a second position of the marker detected by said at least one detector 130. In one arrangement the sensor further comprises a marker generator (a pair of electrodes 130) where said first know position of the marker is determined by the position of the marker generator 130. In one arrangement the sensor 10 comprises a second marker detector 130 to detect said first known position of the marker. In one arrangement the sensor 10 comprises a plurality of marker detectors for detecting multiple positions of the marker along said flight tube. In one arrangement the sensor 10 comprises at least one marker detector 130 that is further utilized to perform time of flight flow measurement. In one arrangement at least one marker detector is utilized to determine diffusion or dissipation of said marker. In one arrangement the sensor 10 is a local compositional variation of said fluid. In one arrangement of sensor 10 the compositional variation is generated by a marker generator 130. In one arrangement of the sensor 10 the marker generator 130 comprises electrodes configured to perform electrolysis of said fluid. In one arrangement the said marker detector is at least one electrode. In one arrangement the sensor 10 the electrodes 130 are configured to sense at least one of a change in conductivity, pH, and capacitance of the fluid.

The disclosure exhibits a method for sensing volumetric flow of a fluid that comprises at least one marker, by utilizing a sensor 10 comprising a body (at least one of 101 and 111) comprising an inlet 105 and an outlet 106 and at least one flight tube 104 there between comprising at least one marker detector 130 disposed along said flight tube configured to detect a position of at least one marker in the fluid; the method comprising: a) Determining a first position of a marker from at least one of the position of the marker generator 130, detection of the marker by at least one marker detector 130, and the flow rate prior to detecting the marker by a marker detector, (b) Determining a second position of a marker from at least one marker detector 130, and (c) Calculating the volumetric flow from at least the marker displacement from said first position to the second position, and the geometry of the flight tube. In one arrangement said marker varies in its composition from the surrounding fluid. In one arrangement the marker generator 130 performs electrolysis of the fluid. In one arrangement the marker detector detects the marker by sensing the variation of at least one of the conductivity, capacitance, and pH of the fluid.

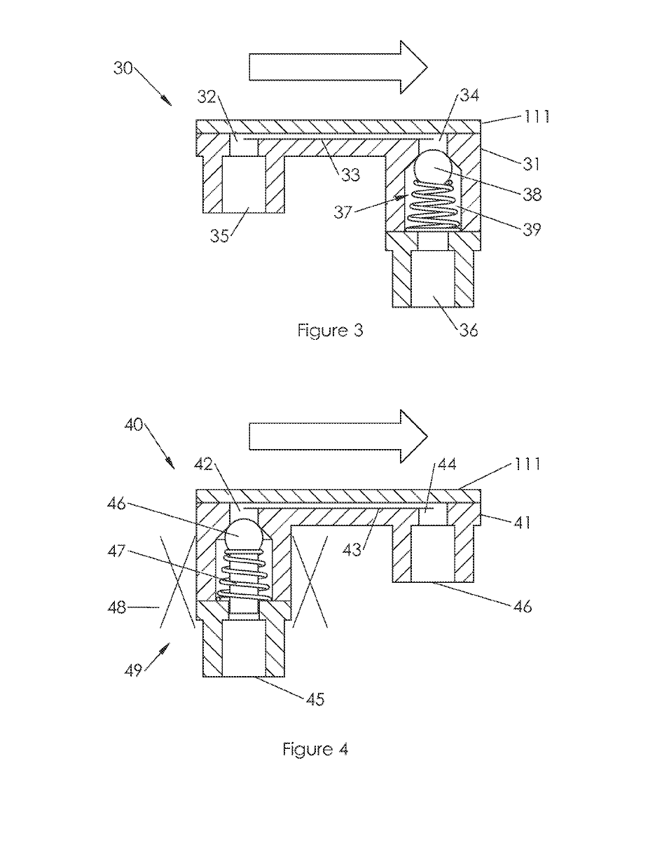

Referring now to FIG. 3, a flow control system 30 is illustrated. The flow control system 30 comprises a channel substrate 31 comprising an inlet port 35 in fluid communication with an inlet bore 32; an outlet bore 34 in communication with an outlet port 36; and a recessed channel 33 interconnecting the inlet bore 32 and the outlet bore 34. An electrode substrate 111 is joined with the channel substrate 31 in a fluid tight fashion forming a flight tube 33 with the electrodes (not shown) of the electrodes substrate reaching into the flight tube. This arrangement is operated by a processor as at least one of a stroke volume displacement flow rate sensor, a time-of-flight flow rate sensor, and a diffusion sensor. A ball check valve 37 is disposed between the outlet bore 34 and the outlet port 36 allowing a unidirectional movement of the fluid in the flight tube 33 as indicated by the arrow. The ball check valve 37 comprises a ball 38 biased by a spring 39 force to seal against a conical surface of the outlet bore 34. A threshold pressure at the flight tube 33 is required to open the valve and allow fluid to move toward the outlet port 36.

According to one arrangement pressure, lower than the threshold pressure, is maintained at the flight tube 33 by a pressure source upstream of the flight tube 33, said pressure can be generated by one of the means known in the art such as a fluid column from a gravity infusion bag, an inflatable reservoir such as an elastomeric pump, other sorts of pumps or a combination of the above; in fluid communication with the inlet port 35 via a tube. In order to open the valve a pressure wave or pressure pulse (the terms pulse and wave will alternately be used in this context) is superimposed in the flight tube 33, such that a momentary pressure exceeds the threshold pressure allowing a stroke of fluid to advance downstream of the valve 37 before the valve is closed again. A marker is disposed in the flight tube and the flow rate is measured according to one of the methods disclosed in the summary. The information of the measured fluid volume that moved down stream is utilized by a processor to determine the following pressure pulse schedule to meet a desired delivery profile. The pressure pulse can be generated by several means known in the art including a vibrator disposed in the flight tube, upstream of the flight tube or in contact with the body of the flow control system 30; the vibrator can be at least one of the vibrators known in the art including a piezoelectric element, a magnetrostict, an electromagnetic oscillator, a rotating cam (driven by a motor or a spring), an actuator, and a combination of the above. In one arrangement the flow control system 30 is interfaced with a vibration device (for instance by clamping or docking the system 30 to said vibration device) and the pressure pulses are achieved by vibrating the system 30. In another arrangement the port 35 is communicating with an upstream tube, said tube interfaces with a vibration device (for instance by clamping the tube in said vibration device); and the vibration device vibrates the tube to create the pressure pulses to open the valve 37. In another arrangement, the degree of opening of the valve is varied by varying the frequency of oscillation of the vibrating device.

In yet another arrangement the valve 37 is opened by relaxing the bias force on the valve by decreasing the spring 39 force. In one arrangement the spring 39 force is relaxed by heating up the spring 39. In one arrangement the spring 39 is made from a memory shape alloy and is deformed by electrical charge. In one arrangement the spring 39 is made from a bi-metal and it deformed by changing its temperature.

In yet another arrangement the valve 37 is opened by manipulating the ball 38 by changing a magnetic field or an electric field.

It would be obvious to those skilled in the art that the ball check valve arrangement can be disposed upstream of the flight tube 33, for instance at the inlet port 35. The flow control device 30 may comprise more than one valve, for instance the valve 37 and a similar valve disposed at the inlet port 36. Other valves can similarly be used for the purpose described above such as diaphragm valve, mitral valve, etc.

More generally FIG. 3 illustrates a sensor 30 comprising at least one flow control device 37 for regulating said fluid flow in at least one flight tube consisting of at least one of a valve, a flow regulator, a pressure regulator, and a pump. The flow control device 37 is configured to produce a volumetric flow stroke of the fluid such that the marker position is detectable by at least one marker detector after stroke has been completed. In one arrangement the flow control device 37 is configured to stop and turn on the flow, where the marker generator generates a marker in the fluid before the flow is opened.

FIG. 4 illustrates another flow control system comprising a flow rate sensor arrangement similar to that of FIG. 3. A check valve is disposed between the inlet bore 42 and the inlet port 45. The valve 49 comprises an actuator 46 comprising a spherical sealing head, biased toward a conical sealing surface of the inlet bore 42, by a spring 47. The actuator 46 further comprises a cylindrical body extending downward through the spring 47 toward the inlet port 45. At least a portion of the actuator is made from ferromagnetic material. An electromagnet 48 is disposed around the inlet port 45, and when activated, pulls the actuator 46 away from the sealing surface, allowing fluid to move through the flow control system 40. According to one arrangement pressure is maintained at the inlet port 45 by an upstream pressure source, said pressure can be generated by one of the means known in the art such as a fluid column from a gravity infusion bag, an inflatable reservoir such as an elastomeric pump, other sorts of pumps or a combination of the above; in fluid communication with the inlet port 35 via a tube. A marker is disposed in the flight tube 43 and the flow rate is measured according to one of the methods disclosed in the summary. The information of the measured fluid volume that moved down stream is utilized by a processor to determine the following valve opening schedule to meet a desired delivery profile.

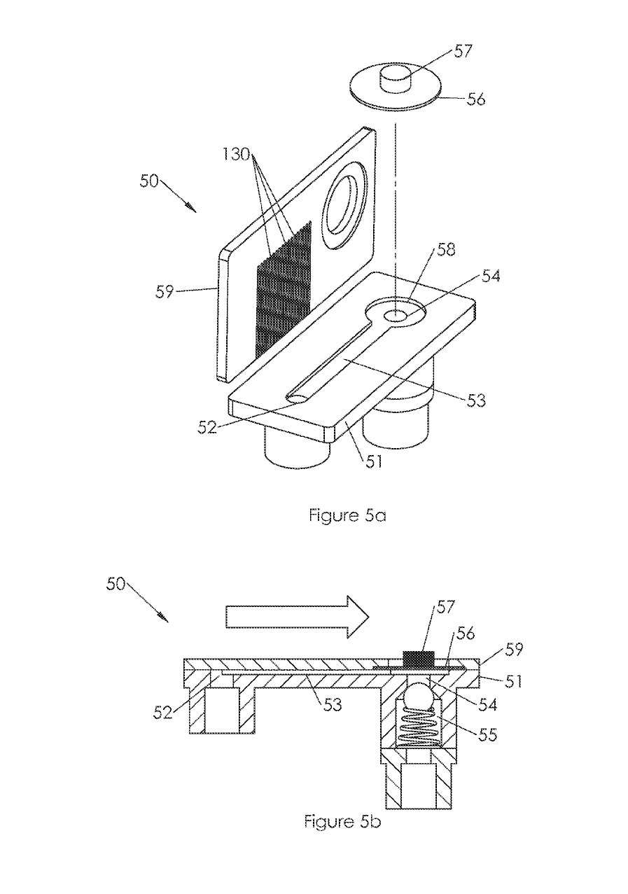

FIGS. 5a and 5b illustrates another flow control device 50 substantially similar to the flow control device 30 of FIG. 3 with the exception that the electrodes substrate 59 and the channel substrate 51 are configured to accommodate a diaphragm assembly 56,57 in confronting relation with the outlet bore 54. The diaphragm 56 is joined between the electrodes substrate 59 and the channel substrate 51 in a leak tight fashion. The diaphragm 56 is manipulated by the diaphragm actuator 57 to create pressure pulses in the flight tube 53 that exceed the threshold pressure of the valve 55 allowing a stroke of fluid to advance in the direction of the arrow. In one arrangement a second check valve is disposed upstream of the flight tube 53 and is openable to allow flow in the direction of the arrow. The diaphragm can be actuated by several means known in the art. In one arrangement the diaphragm actuator comprises a magnet or ferromagnetic material and is manipulated by changing a magnetic field. In one arrangement the actuator 57 is an electric vibrator. In one arrangement the diaphragm actuator 57 is mechanically operated by another actuator such as a rod or a cam. In one arrangement the diaphragm actuator is merely a body having sufficient mass to operate the diaphragm when the flow control device is accelerated, for instance in response to vibration that are imposed on the flow control device.

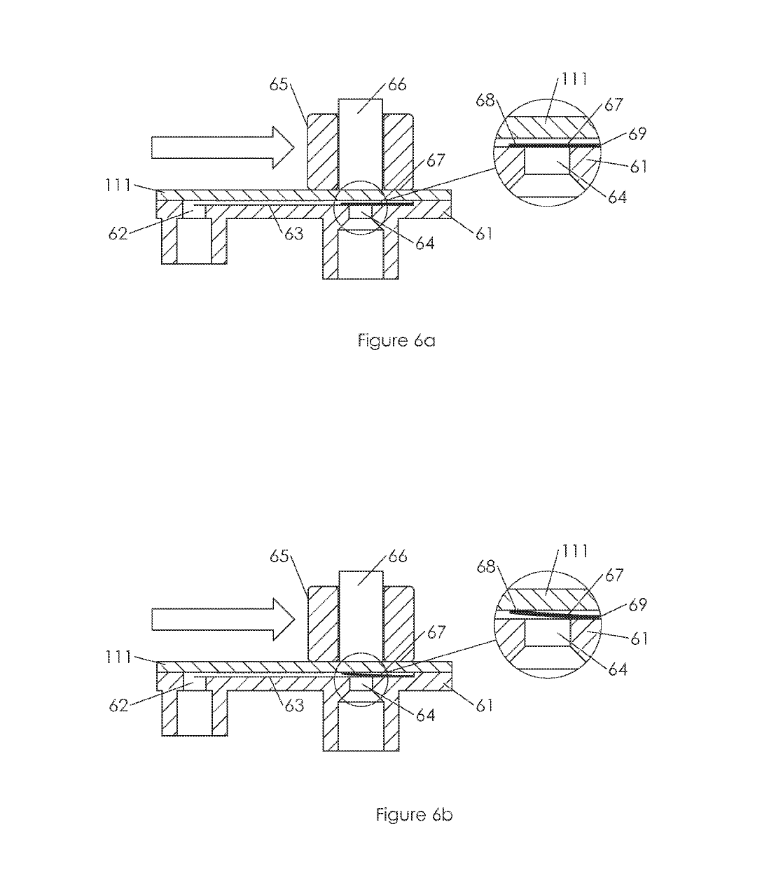

FIGS. 6a and 6b illustrate another flow control device 60 comprising a flow sensor similar to the one of earlier Figures, and further comprises a check valve comprising a leaf spring 67 comprising a distal sealing portion 68 in confronting relation with the outlet bore 64; and a proximal end 69 fixed to the channel substrate 61, such that the distal end 68 is biased to seal against the outlet bore 64, as shown in the close position configuration in FIG. 6a. The flow control device 60 further comprises an electromagnet 65 with a core 66 in confronting relation with the distal end 68 of the leaf spring 67. At least a portion of the leaf spring comprises a ferromagnetic material that is pulled away from the sealing position when the electromagnet 65 is activated, opening the valve and allowing fluid to move in the direction of the arrow toward the outlet bore 64. In another arrangement the magnetic field is provided by a permanent magnet. In another arrangement the leaf spring comprises a bi-metal. In another arrangement the spring comprises a memory shape alloy.

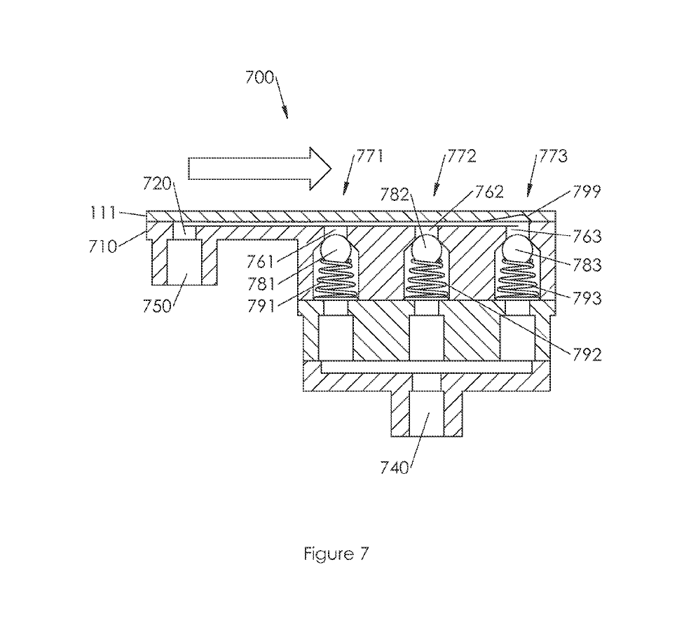

FIG. 7 illustrates flow control devices 700 which contains multiple valves 771, 772, and 773 configured in parallel between a flight tube 730 and an outlet port 740. The flow control system 700 comprises a channel substrate 710 comprising an inlet port 750 in fluid communication with an inlet bore 720; an outlet port 740 in communication with outlet bores 761, 762, and 763; and a recessed channel 730 interconnecting the inlet bore 720 and the outlet bores 761, 762, and 763. An electrode substrate 111 is joined with the channel substrate 710 in a fluid tight fashion forming a flight tube 730 with the electrodes (not shown) of the electrodes substrate reaching into the flight tube 730. This arrangement is operated by a processor as at least one of a stroke volume displacement flow rate sensor, a time-of-flight flow rate sensor, and a diffusion sensor as described in the context of earlier Figures. Ball check valves 771, 772, and 773 are disposed between the outlet bores 761, 762, and 763 and the outlet port 740 allowing a unidirectional movement of the fluid in the flight tube 730 as indicated by the arrow. The ball check valves 771, 772, 773 comprise balls 781, 782, and 783 biased by springs 791, 792, and 793 force to seal against a conical surface of the outlet bores 761, 762, and 763. A threshold pressure at the flight tube 730 is required to open the valves 771, 772, 773 and allow fluid to move toward the outlet port 740.

In one aspect of this embodiment these valves 771, 772, 773 are essentially equivalent to each other. In another aspect of this embodiment, these valves differ in their size, orientation, stiffness, resonant frequency, etc. For example, in one aspect the springs 791, 792, and 793 have different stiffness and different resonant frequencies. In one aspect the valves can be individually actuated, for example by applying current to an individual spring such as 791 in order to heat it to relax the stiffness of just that spring without any similar effects on neighboring springs 792 and 793.

In one aspect a pressure raising device is disposed in fluid communication with the valves 771, 772, 773, and applies a pressure wave to the valves via the fluid path along the length of flight tube 730. In another aspect, a pressure raising device is applied above the flow control device 700, or anywhere that allows the pressure wave to reach the fluid.

In one aspect, the valves are actuated in tandem. In one aspect, the relative actuation of each valve varies as a function of the excitation of a pressure-raising device. In one aspect, the pressure raising device is a vibrating element or acoustic element and frequency of excitation is varied. In one aspect, a single valve is selected for greater actuation than its neighbors by selecting the actuation frequency of the vibrating element to match the resonant frequency of that single valve. In one aspect multiple vibrating elements are used in the system at different positions, and apply different actuating forces to the set of valves, so that the ratio of forces experienced by each valve relative to the others is different when different actuators are used. In one aspect the system contains at least one pressure-reflecting structure 799, which has the function of either focusing or reflecting the pressure applied to at least one valve by the actuating element.

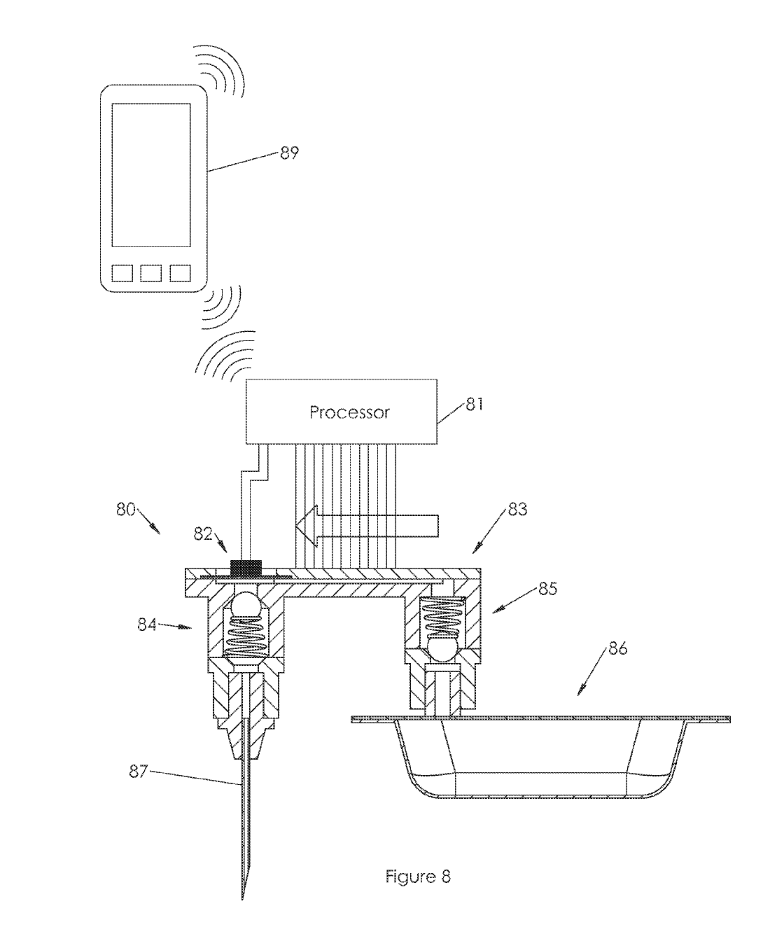

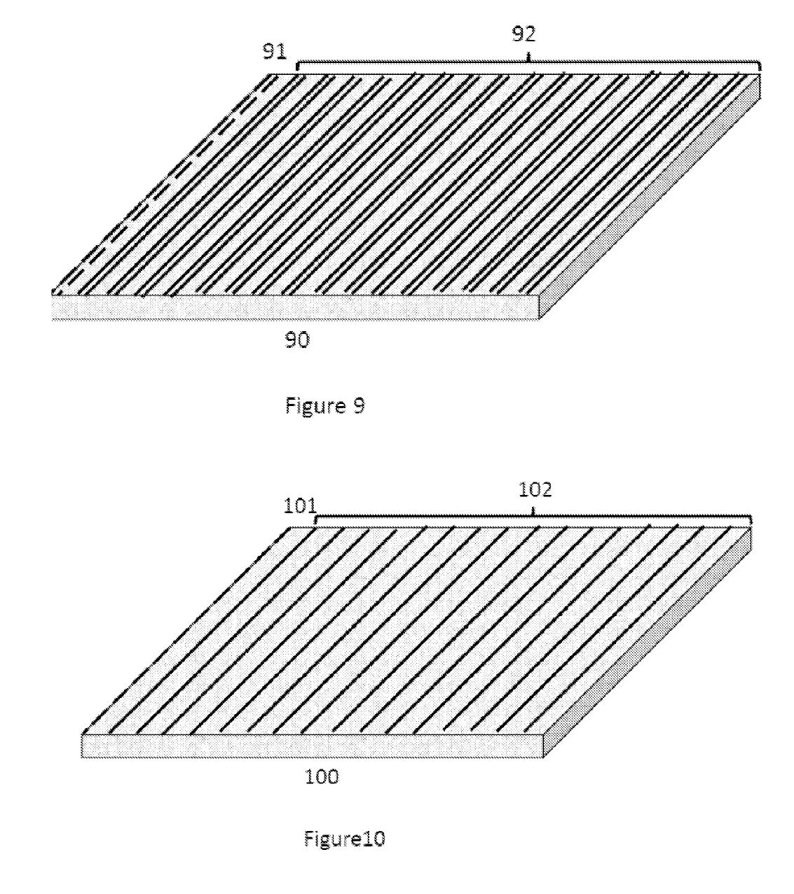

FIG. 8 illustrates a drug delivery system comprising a self-contained drug delivery device 80 and a control device 89. The device comprises a body comprising an inlet port 85 comprising a check valve; and an outlet port 84 comprising a check valve; at least one flow sensor 83 comprising at least one flight tube interconnecting there between; an administration device 87, in a form of a hypodermic needle, communicating with said outlet port 84; and a reservoir 86 in a form of a flexible and collapsible blister (or pouch, sachet . . . ) communicating with said inlet port 85. The drug delivery device 80 further comprises a pump 82 in the form of an oscillating device as described earlier. A processor 81 commands the operation of the drug delivery device 80. When the processor 81 activates the pump 82, pressure is generated which forces the check valve at the outlet port to open and deliver fluid to the administration device 87. The inlet valve at the inlet port 85 allows fluid to flow into the flight tube of the flow sensor 83 and compensate for the delivered volume, while the reservoir 86 collapses as its volume depletes. The processor 81 operates the electrodes of the flow sensor 83 and implements at least one marker in the flight tube. The processor 81 traces the marker by one of the flow rate sensing processes described earlier and interprets the flow. The processor 81 updates the pump operation schedule and regime based on the flow rate information and/or the integrated volume of fluid delivered over a time period. The processor detects and alarms of problems if the flow rate is inconsistent with the pump operation. The delivery device 80 may further comprise additional sensors including at least one temperature sensor and at least one pressure sensor. The processor 81 may further analyze other conditions of the fluid such as temperature, pressure, backflow, pH, conductivity, viscosity, and may be programmed to do at least one of communicating this information, set off alarms or notification and confirmations, and take independent action if certain threshold values or uncertainties about the pump operation exist. The processor 81 communicates with a control device 89 to do at least one of (a) program the processor 81, (b) override the independent program and outputs of the processor to the pump, (c) communicate data from the processor 81 to the control device 89, (d) send notifications, proper operation confirmations, or alarms, (e) communicate delivery device functionality diagnostics, (f) communicate control device 89 diagnostics, (g) communicate information from other sensors from the processor 81 to the control device 89, (h) communicate identification information of the delivery device 80 and the control device 89, and (i) communicate in-range and/or out-of-range information. In one arrangement the processor is pre-programmed. In one arrangement the processor 81 communicates semi-processed information from at least one sensor to the control device; the control device may process the information or transmit the information forward to be processed elsewhere. In other arrangements the pumping mechanism 82 may be replaced with other pumping mechanisms including at least one of a positive displacement device, a turbo-machine, and a peristaltic pump. In another arrangement the reservoir 86 is pressurized. In another arrangement the reservoir is rigid and the depleted fluid volume is compensated with gas from at least one of a venting device or a phase change. In one arrangement the reservoir comprises a piston and cylinder arrangement. As discussed in context of earlier Figures, in other arrangement the valves may be replaced with other valve types and constructions known in the art. In other arrangements the administration device can be at least one of an intradermal needle or catheter, a subcutaneous needle or catheter, an intradermal needle or catheter, an IV needle or catheter, a cross-dermal administration patch, a tube, a pipe, a hose, a weak, and a connector, fitting or interface to the above.

FIG. 9 shows a picture of an example channel 90, which contains 1 write electrode pair 91 and 16 pairs of read electrodes 92. FIG. 10 shows an example channel 100, which contains 1 write electrode and 16 read electrodes, where a read electrode may be used transiently as the ground electrode during a write pulse, and where another read electrode or the write electrode may be used transiently as the ground electrode during a sensor read operation.

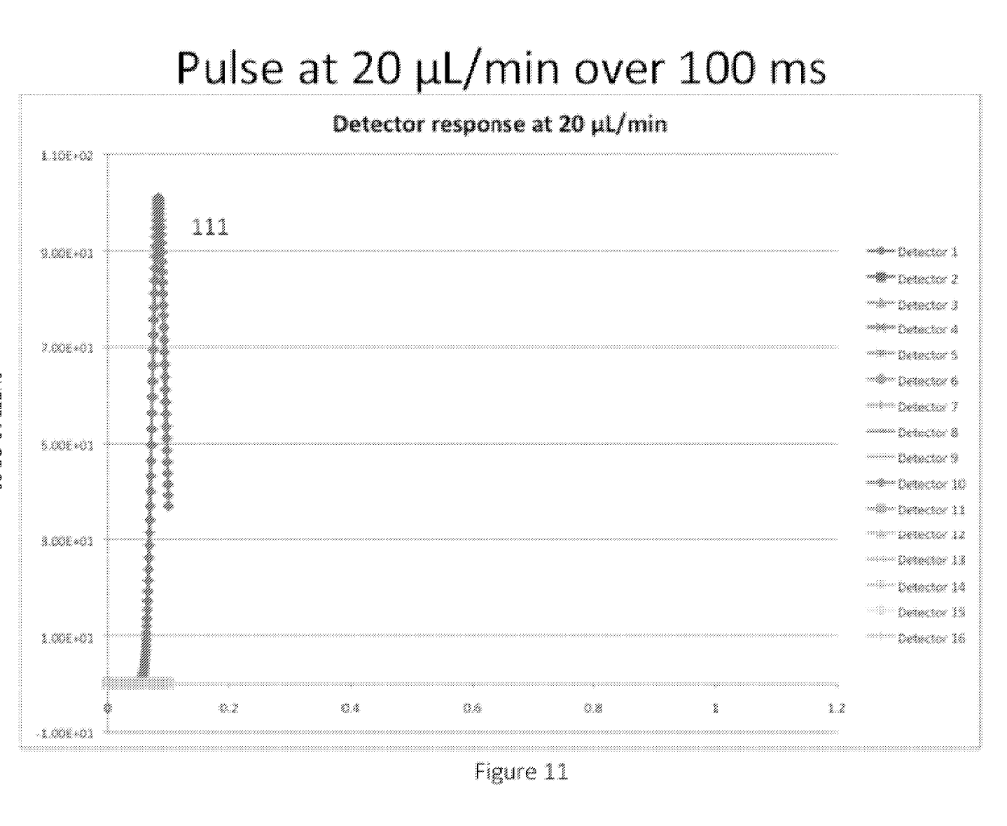

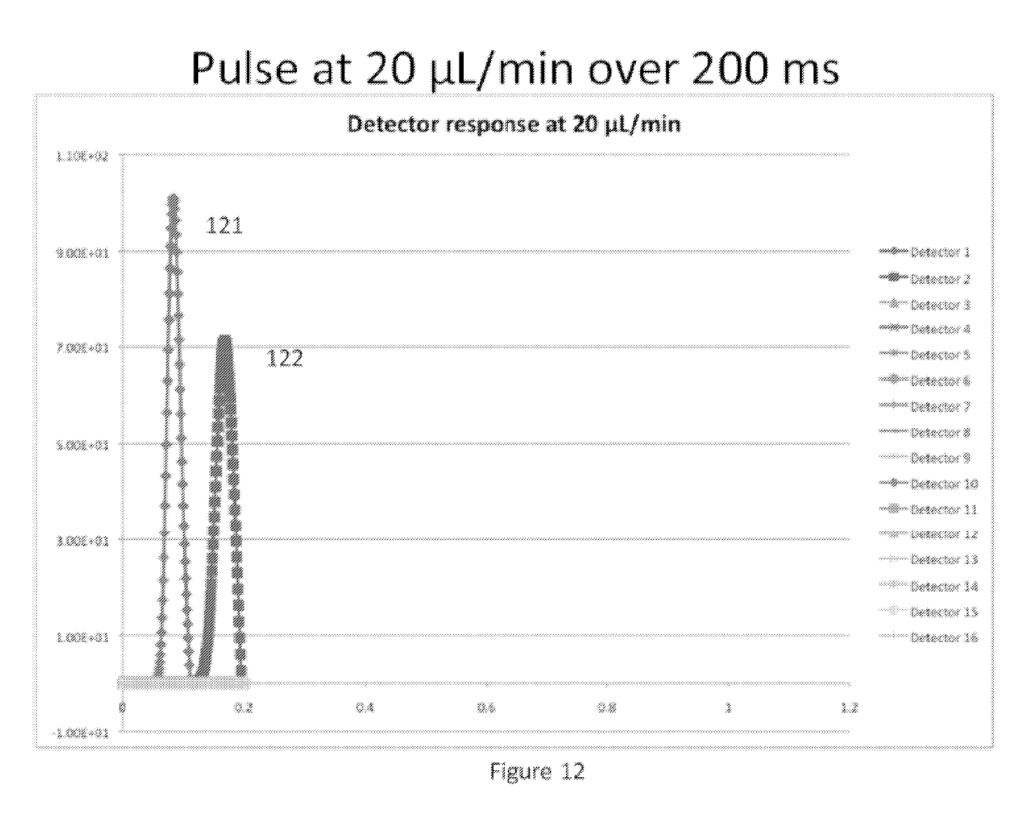

FIG. 11 shows simulated sensor data for a pulse traveling through such a channel, where the channel dimensions are 5 mm long, 6 mm wide, and 15 μm deep, at a flow rate of 20 μL/minute, with read sensors 312.5 μm apart and evenly spaced. The amplitude of the read trace 111 represents the signal coming from the first sensor, where the first peak arises from the read electrode pair closest to the write electrodes; a further second peak would arises from the read electrode pair second-closest to the write electrode, etc. From FIG. 11, it is evident that in 100 ms, the center of the marker has past the first electrode pair, but not yet reached a second.

This sensor signal allows its position to be identified, as it is known that it is more than 312 μm beyond the write electrode, but less than 625 μm.

Similarly, in FIG. 12 we have recorded two traces 121 and 122 representing a signal registered over time at two different electrodes. At 200 ms the center of the marker is greater than 625 μm from the write electrodes, but less than 932 μm. No signal has yet been registered at any further downstream electrodes during the 200 ms travel time.

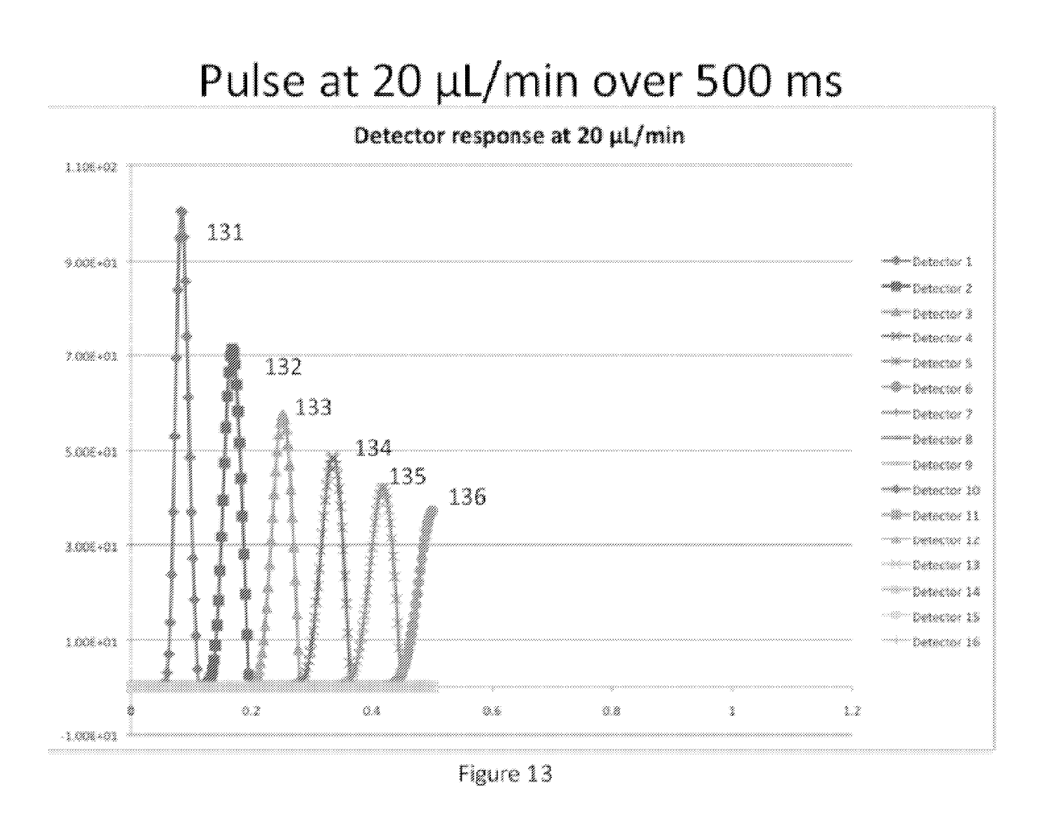

FIG. 13 shows the peak has traveled downstream and its presence has been registered in peaks 131, 132, 133, 134, 135, and 136, corresponding to read signal registered at the first 6 electrodes. Based on these measurements, the center of the marker is inferred to almost exactly lined up with the position of the 6^{th} read electrode, at 1.875 mm downstream from the write electrode.

Thus, using a simple analysis of which sensors have registered a signal, it becomes possible to identify a small range for the potential volume of the pulse. The pulse volume can be further refined by analysis of the peak shape. For example, in FIG. 12 at 200 ms it is evident that the marker has completely passed by the second sensor, but not yet triggered the third. Based on a computational model of the sensor system, it is expected that for such a result the marker must be positioned almost exactly between the two sensors, at about 790 μm from the write electrode. Similarly, in FIG. 13 at 500 ms, the peak shape is analyzed and the marker is found to be essentially at its peak at the marker at 1.875 mm at this time.

The read signal can be further analyzed to identify the flow rate as a function of time, as the signal passes from marker to marker. Thus, very small variations in flow rate are easily detected using this method.

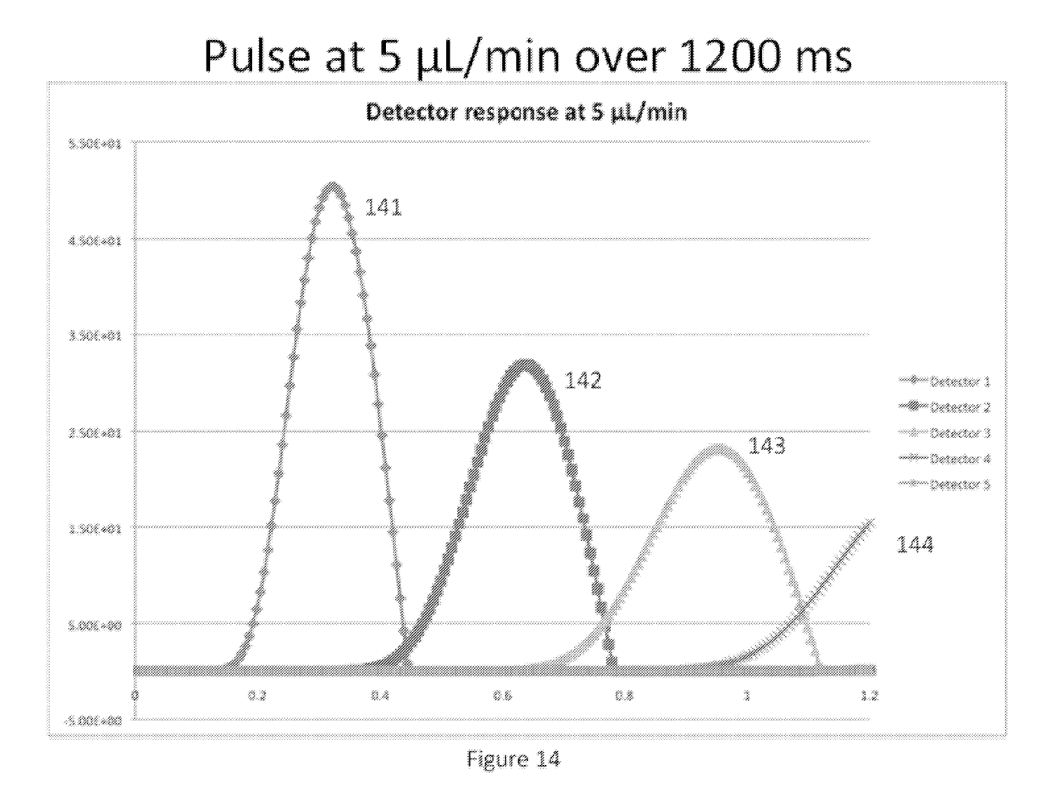

The read signal can be further analyzed to identify the viscosity of the fluid. To illustrate this, FIG. 14 shows simulated results for the same channel, with a flow rate of 5 μL/min, over a time of 1200 ms. During this flow period the marker has come in contact with four different read sensors to produce four read signals 141, 142, 143, and 144. It is evident from this image that at this slower flow rate, the breadth (extent of diffusion) of the marker starts to become comparable to the extent of travel of the marker, and two sets of adjacent sensors may positively identify the presence of the marker at a given time (e.g., at 1100 ms, both signal 143 corresponding to data from the third read electrode, and signal 144 corresponding to data from the fourth read electrodes indicate the presence of a signal). The rate of diffusion of the marker is inversely proportional to the viscosity of the system, as the breadth of the marker will increase in less viscous systems and decrease in more viscous systems. The specific extent of the marker can be estimated by analyzing the peak shape at a given time. This can be accomplished, for example, by comparing the peak shape at a time to that predicted by Fick's Law of Diffusion, where diffusion extent depends on time and the diffusivity of the fluid, and where the diffusivity is proportional to 1/viscosity for homogenous fluids. Thus, this system advantageously measures viscosity as well.

This viscosity measurement may be further refined by analyzing viscosity at each of the read electrodes, so that multiple viscosity measurements may be made on a single fluid in a short period of time, and these measurements may be averaged to improve the precision of the measurement. This system may also be used to monitor the viscosity of the fluid over longer time periods to detect changes in viscosity of the fluid, for example as a function of temperature. Thus, this system further can function as an indirect measure of temperature as well.

The viscosity measurements may be further applied as an input into the measurement of flow, as the time of flight of the marker depends weakly on viscosity for very high flow rates. Thus, the viscosity measurements may be used as part of the equation that converts time of flight into flow rate.

The peak amplitude and peak shape measurements at multiple electrodes may also be useful in the identification of bubbles. For example, if a bubble is entrained in the flow it may temporarily block a read electrode, dropping the amplitude of the signal at this electrode. Thus, unexpected changes to the read signal at a single electrode or small number of electrodes may be used as a method for bubble detection. Because of the high redundancy of this system, even if a single electrode or several electrodes are temporarily disabled by the presence of a bubble, useful information about flow rates and volumes is still obtainable from the data collected by the remainder of the sensors. In some embodiments, a statistical test is applied to the data from the electrode to identify if measurements from a given time period are statistically different from measurements before that time period, and this is used to inform the system of whether bubbles are present.

There are several forms in which the sensor can be constructed. In one arrangement the sensor is formed by a first substrate comprising an inlet port and an outlet port and a channel there between embossed at its surface; and a second substrate comprising electrodes at its surface; and the first and second substrates are joined to form a closed conduit with the electrodes exposed at one of its surfaces. The electrodes on the second substrate lead to contact tabs that communicate with a processor. The substrate can be made from various materials including glass, silicone, plastic, other materials known in the art or a combination of the above.

In another arrangement the sensor is constructed by drilling a hole vertically through a substrate consisting of multiple layers of electrodes and insulators. This differs from electroded manufactured by current techniques, wherein a channel is carved horizontally in a substrates. The vertical approach may be useful in this stroke volume sensor construction as well as general compositional time of flight flow sensing.

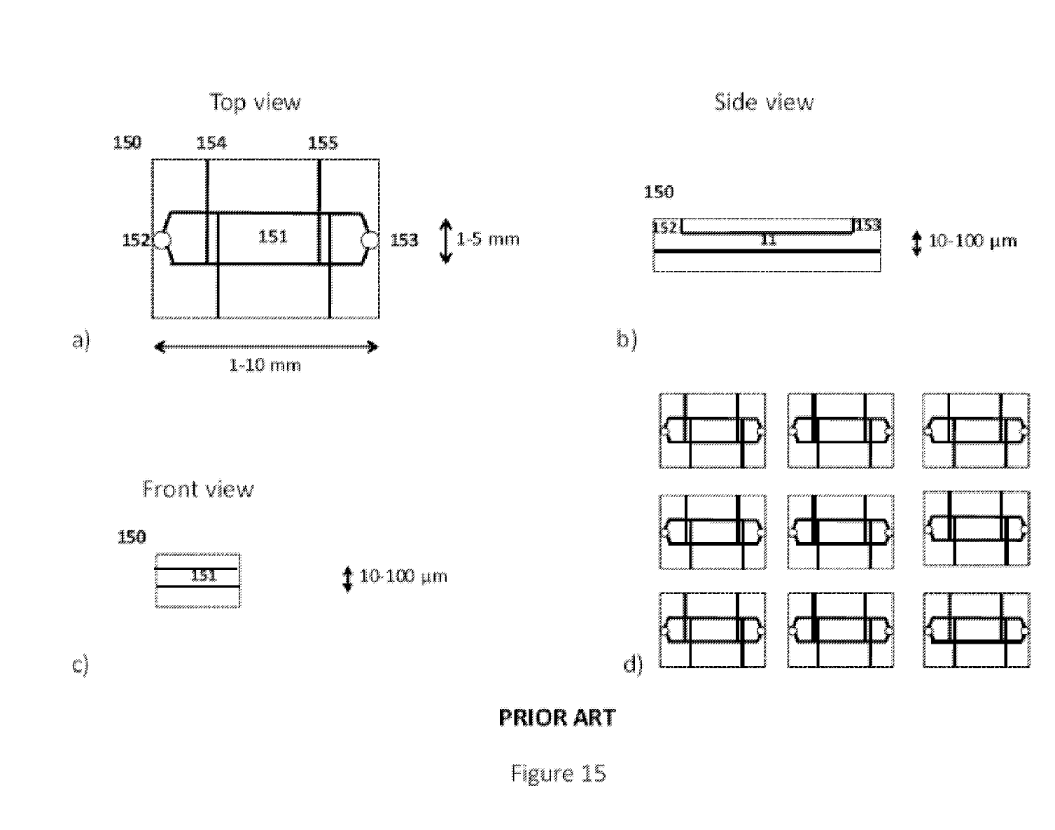

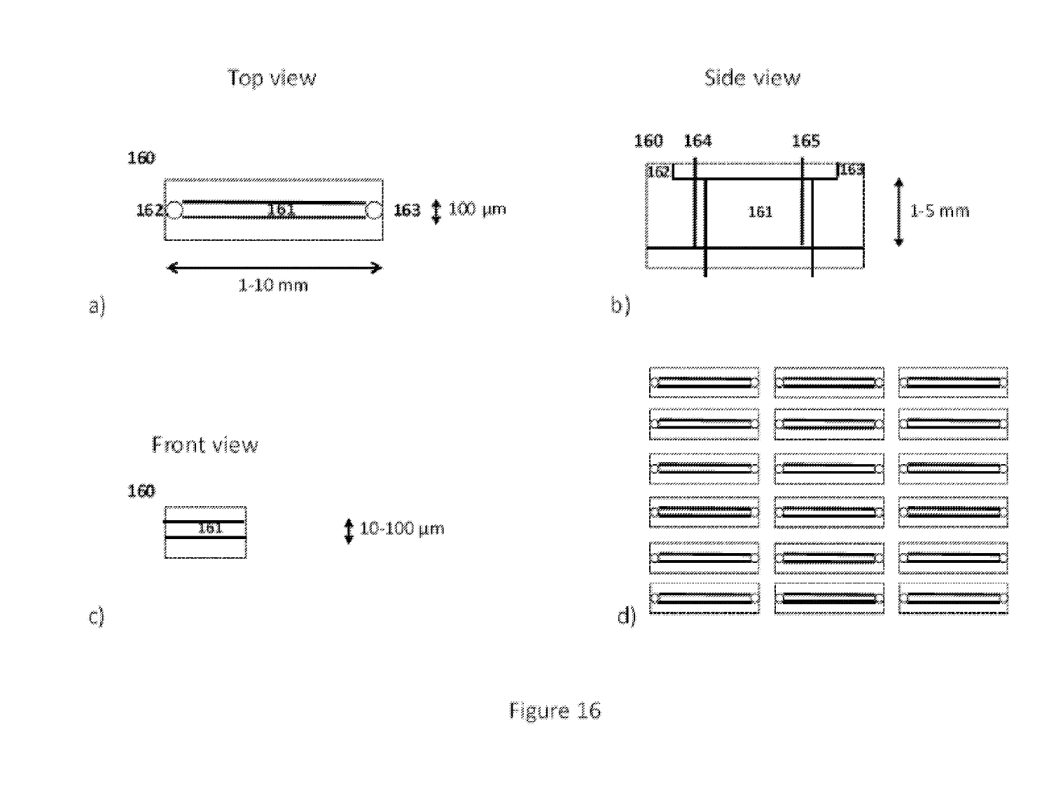

An example flow sensor manufactured using current techniques is shown in FIG. 15. This sensor is simplified to show just two sets of electrodes—two write electrodes and two read electrode—for clarity, but those skilled in the art will immediately see that it can be expanded to multiple electrode configurations with minimal changes. In this Figure, sensor 150 consists of a flow channel 151, an input port 152, an output port 153, a set of write electrodes 154, and a set of read electrodes 155. The input and output ports for the channel are both disposed as holes in the top of the channel, so that the flow is directed downwards into the channel, through its volume, and then upwards back out of the channel. The read electrodes 155 span across the width of channel 151 at a length of approximately 1-5 mm, and are generally each extend approximately 1-100 μm along the axis of the flow channel.

The amount of area consumed on a wafer is represented from the Top View a) of FIG. 15, and the layout of these die on a wafer are shown in View d) of FIG. 15. As can be seen, the smallest dimension of this system is the depth of the channel, 10-100 μm, whereas the width and the length of the channel are much longer, and space is set aside along the channel length for the input and output ports. From the perspective of maximizing the number of die per wafer, it would be preferable to rotate the die, so a smaller cross-section of the channel faces the top.

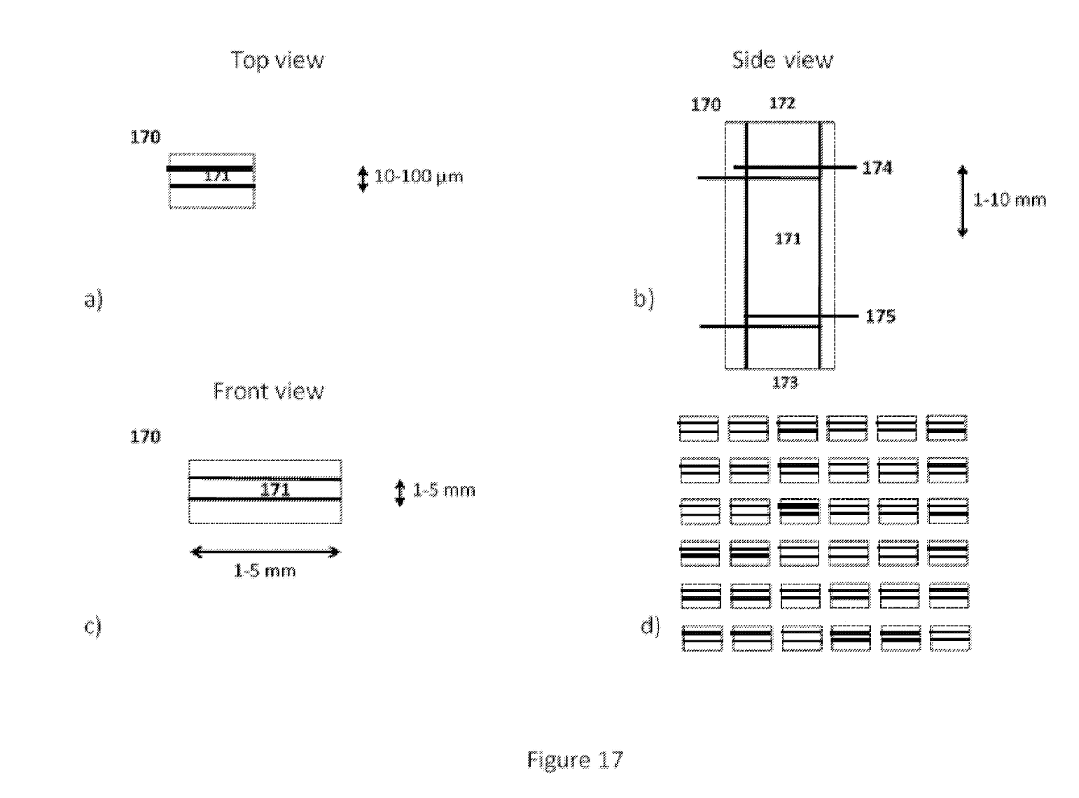

Two alternate configurations are shown in FIGS. 16 and 17. In FIG. 16, the planar configuration of the flow channel is maintained, but the width and depth of the channel are flipped, so that the channel is 1-5 mm deep, but only 10-100 μm wide. The advantage of this configuration is that the total cross-section of the top view is drastically reduced, enabling more die per wafer. The input 162 and output 163 of the channel are both in the top of the structure and are patterned into the wafer layout in View d).

However, this configuration is challenging to produce and use for two reasons: First, the depth of the channel is too great to be controlled tightly in a timed HF etch. Secondly, for operation of a composition time of flight flow sensor and many other devices it is preferable that the electrodes span the narrowest dimension of the channel, ensuring that signal/noise losses to diffusion are minimized. To meet this goal, in this suggested geometry the electrodes must be disposed vertically, perpendicular to the plane of the substrate. While it is trivial to manufacture horizontally disposed electrodes using a sputter deposition process, it is not possible to pattern and deposit electrodes along vertical structures, and this construction is thus not feasible using conventional manufacturing approaches.

In the system of FIG. 17, the dimensions are rotated so that the fluid enters through port 172 at the top of the chip and exits through port 173 at the bottom of the chip. This design represents a significant departure from the original geometry, because the fluid no longer enters and exits perpendicular to the plane of the channel, but instead flows along the channel axis with no turn. The layout of these die on a wafer is shown in View d), and it can be seen from this drawing that there is no requirement for input and output ports to be separately patterned on the wafer, and that this configuration represents the densest packing of the three.

The electrodes in this configuration are disposed in the plane of the wafer, so that they are easily fabricated. However, the system is not amenable to HF etching or conventional microfluidic processes, as it requires a via through the silicon wafer.

An important aspect of the design in FIG. 17 is that the input and output ports 172 and 173 are in line with each other and the channel 171. As a result, there is no space in the construction dedicated entirely to the input and output ports, and more die per wafer result. FIG. 17 thus represents an ideal geometry for the formation of fluidic devices such as flow sensors.

This structure has not been previously suggested as a design for several reasons: First, the fluid path length is very short, and conventional microfluidic sensors have difficulty fitting into such a minimal path length. Secondly, this approach is not compatible with existing techniques of building microfluidic devices. Thus, there has neither been the impetus nor the capability to provide flow sensors of this geometry.

Third, the electrodes themselves are again disposed vertically in the channel, which would initially appear to be a significant barrier to the use of this structure. However, we have found that the thickness of the electrodes, rather than their length, can be used to define the extent of the electrodes, as will be explained below.

Through via technology (TV) includes thru silicon vias (TSV) and thru glass vias (TGV), and is commonly used in the semiconductor industry to make vertical interconnects in between devices, in order to increase the total number of devices available per wafer. In this invention, we proposed to use TV to fabricate vertical channels or vertical electrodes for use in a microfluidic sensor device, such as a microfluidic flow sensor.

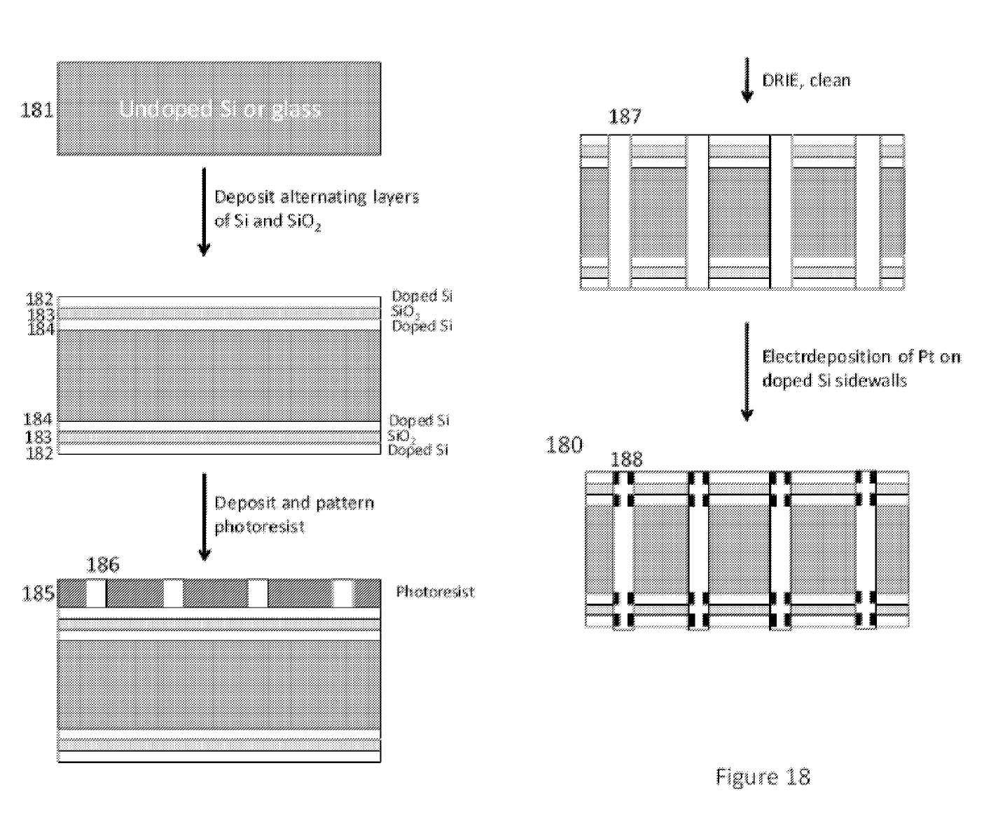

An example method of fabricating the geometry of FIG. 17 is shown in FIG. 18. In this example, an insulating silicon or glass wafer 181 is used as the channel layer, and it is overcoated by a first layer 182 of conducting silicon, a second layer 183 of insulating silicon dioxide, and a third layer 184 of conducting silicon (note that patterning and routing of the electrical contacts are omitted for clarity in this example). In one embodiment, at least one of these layers is in the range of 1-100 μm. In one embodiment, at least one of these layers is about 5 μm. In this example, the coating is done on both sides of the wafer, though it could be done on a single side and subsequently bonded to an identical, single-side wafer in a subsequent step.

After the deposition steps, the system is patterned using a through via process, such as DRIE, the Bosch process, wet chemical etch, or laser etch. In one example, the via is patterned by DRIE by first applying an etch mask such as SAP100 (Silec Corp), then applying a photoresist on top of the SAP100, patterning the resist, removing the exposed SAP100 using a selective dry etch technology, and then removing the resist. Then the wafer is exposed to the DRIE plasma process to drill the via through the locations there SAP100 was etched, and in a final step the SAP100 is stripped and the wafer is washed. In another example, a single photoresist capable of protecting the wafer from a wet etch is spun onto the wafer and patterned before using a wet etch step, and there is no need for a second masking layer such as SAP100. In another example, a laser process is used and no patterning/masking is required.

In each case, the extent of the electrodes along the channel axis is defined by the thickness of the conductive layers 182 and 184, rather than by lithography. The desired 1-100 μm extent is very compatible with deposition processes that can deposit 1-100 μm thick materials. Thus, surprisingly, we have found that we can use the thickness of the layers to define the extent of the electrodes and their separation from each other and from other electrode pairs, and thereby create a flow sensor with precisely defined geometric parameters, with a need to use lithography to define only the channel cross-sectional dimension and the bond pad routing and layout.

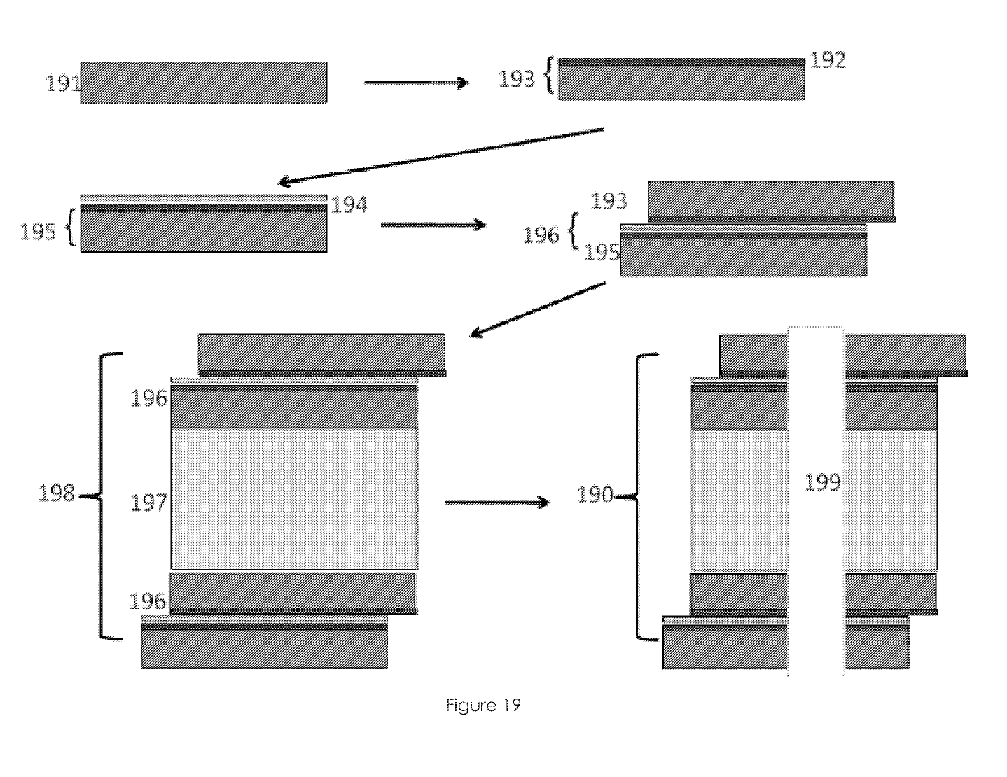

FIG. 19 shows a similar flow sensor 190 fabricated using a polymer process. In this process, a sheet of plastic 191 is coated with a metal 192 such as nickel (e.g. 5-10 μm) to form metalized sheet 193. A sample of this metalized sheet is coated with a thin polymer 194 (e.g., 5-10 μm) to form coated sheet 195, which is mated to another sample of 193 to form electrode structure 196. This is shown in a staggered configuration in the drawing to represent the capability to access each electrode layer individually without contacting the other; the specific geometry of the configuration may vary, as long as electrodes are individually accessible. This electrode structure is laminated above and below a thicker sheet of plastic 197 (e.g., 0.5-1 mm thick) to form superstructure 198. A hole is drilled in this structure by a process such as laser micromachining to create channel 199.

An inert electrode material such as platinum, iridium, platinum-iridium allow, or iridium oxide may be deposited over the exposed electrodes in the channel by electrode position. In one example, this is accomplished by flowing a platinum chloride electrolyte solution into the channel and applying a reducing voltage across the electrodes relative to a counter electrode (not shown) to plate platinum on the exposed nickel sidewalls in the channel.

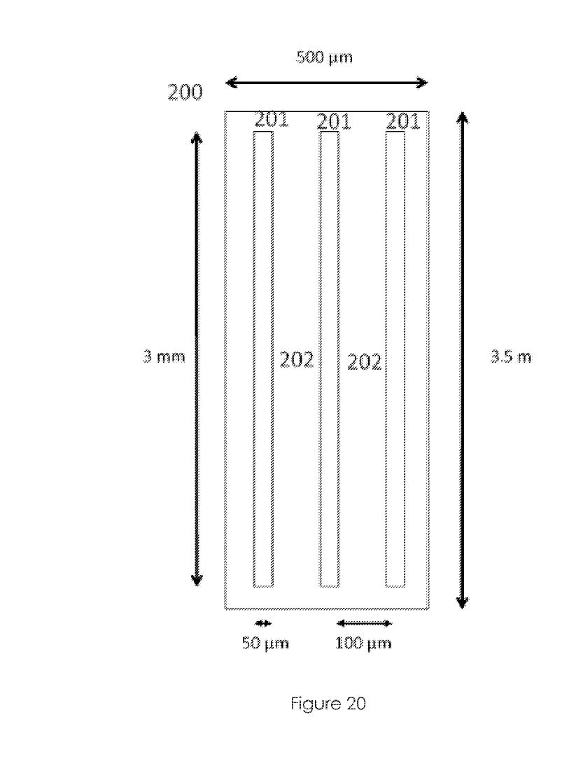

Whether manufactured using a semiconductor or plastic process, a flow sensor of this construction is uniquely capable of providing multiple channels in parallel in a single die. Because the signal/noise ratio of a compositional time of flight flow sensor decreases as the smallest channel dimension increases, it is advantageous to provide for multiple thin channels in parallel rather than a single, larger channel. An example of this construction is provided in FIG. 20, where flow sensor 200 is composed of three 50 μm wide channels 201 separated by 100 μm gaps 202, rather than a single 150 μm channel (note: drawings are not to scale). In operation, flow proceeds down each of the three channels at the same rate, so that the flux is equivalent to that of a single 150 μm channel, but the signal to noise is many times better. In this example, vertical channel construction enables extremely size-efficient packing, far better than that would be possible by stacking individual die of conventionally produced devices to achieve the same effect.

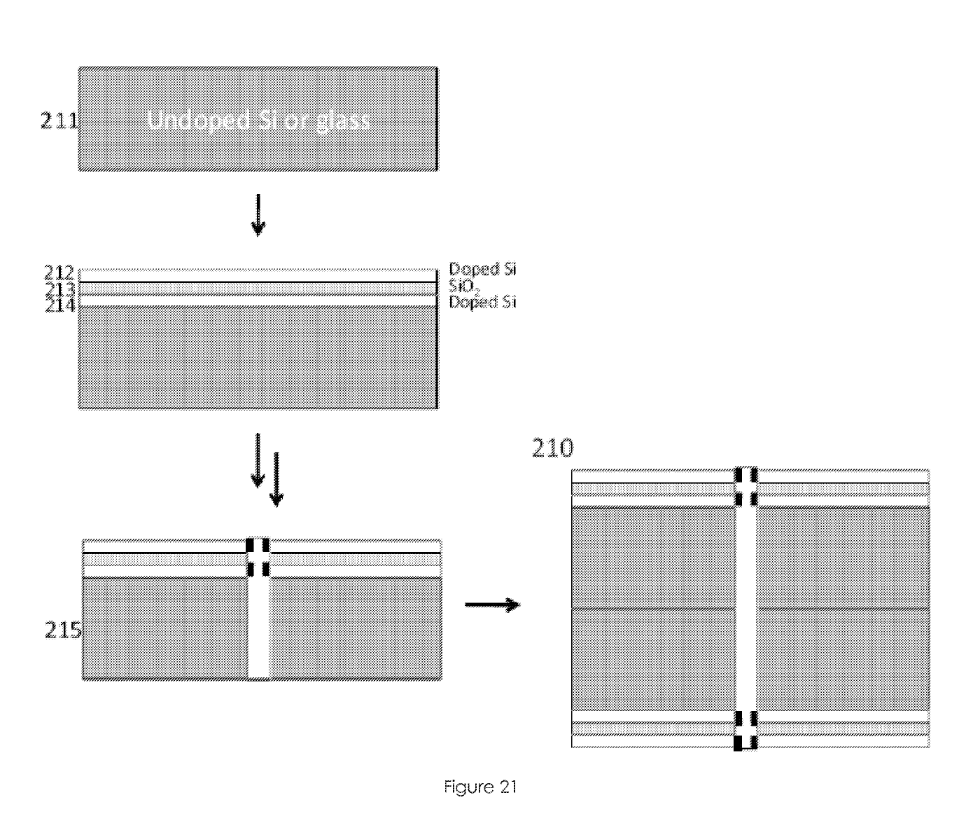

It is evident based on these ideas that more complex structure can be built using these elements. For example, in FIG. 21 silicon or glass wafers 211 are patterned with electrode layers 212 and 214 on a single side, and the processes detailed above are used to pattern vias and deposit metal on the channel sidewalls to form wafer 215. Two wafers 215 are then aligned and bonded using a conventional silicon wafer bonder to create flow sensor 210, which may have a greater thickness than a sensor built on a single wafer. Further, the wafers may be thinned as part of this process to produce a wafer stack of total thickness ranging from 0.1 to 1.5 mm.

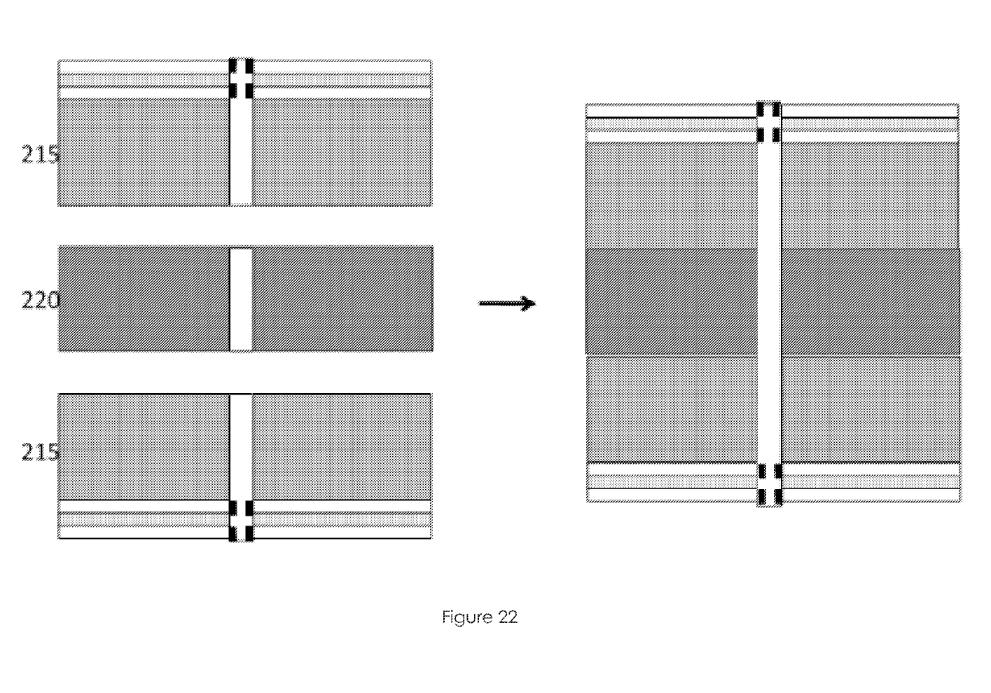

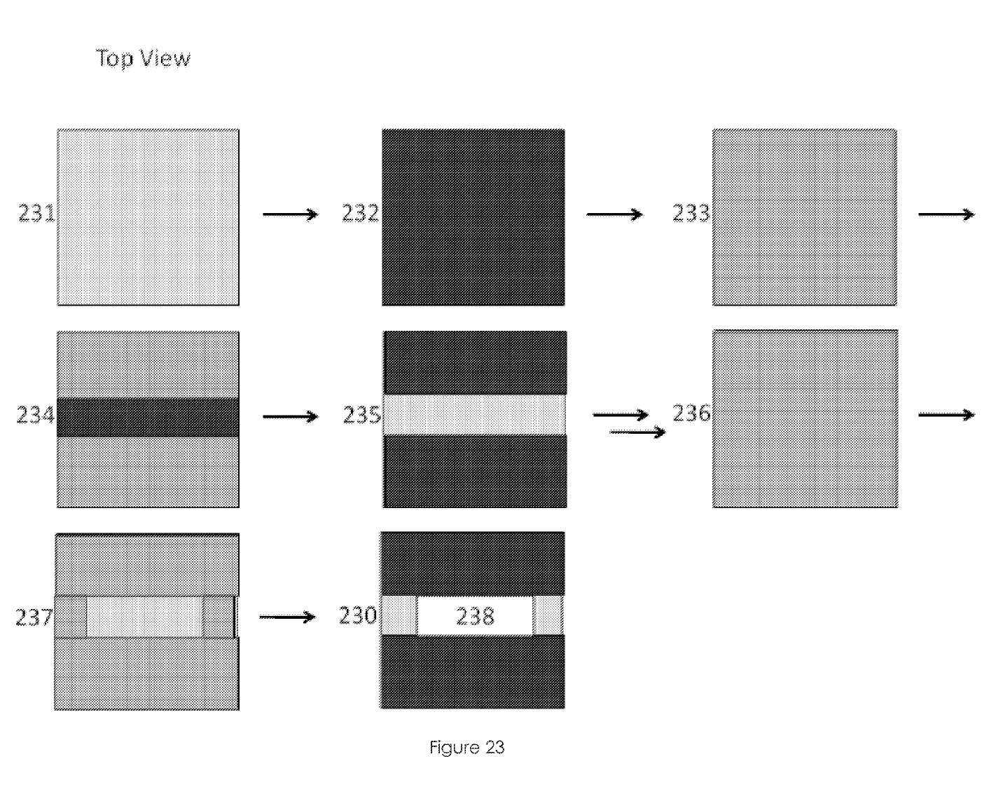

Additional wafer patterned with vias but no electrodes may be further used as interposer layers. For example, in FIG. 22 wafers 225 are bonded to interposer wafer 221 to form sensor 220, with a total channel length that can be higher than a single-wafer or two-wafer sensor. Similar structures can be built out of polymer rather than a silicon or glass wafer as well.

The system may be further adjusted so that the conductive layers and insulating layers are patterned subsequent to the deposition process. In FIG. 18, the conductive layer completely surrounds the channel wall, touching all sides of it. By contrast, in FIG. 23, the conductive layer is patterned after deposition, so that it only touches the long axis of the channel cross-section. In an example, wafer 231 has conductive layer 232 deposited in a blanket layer across its surface, and then this conductive layer is coated by photoresist 233, which is patterned and developed to yield patterned wafer 234. Photoresist 233 may alternatively combine an etch stop layer and a photoresist layer, in applications where a photoresist mask is not sufficient for subsequent etch processing.

Patterned wafer 234 is subject to an etch process to remove the conductive layer in the patterned areas, and the resist is removed to yield patterned wafer 235. At this point, additional processing may be performed, such as the deposition of subsequent layers, which may themselves be patterned using processes such as in this example. In a final step, the wafer is coated by a photoresist or combination photoresist and etch stop layer to yield wafer 236, which is then yield patterned wafer 237 and etched to create a channel 238, yielding sensor 230.

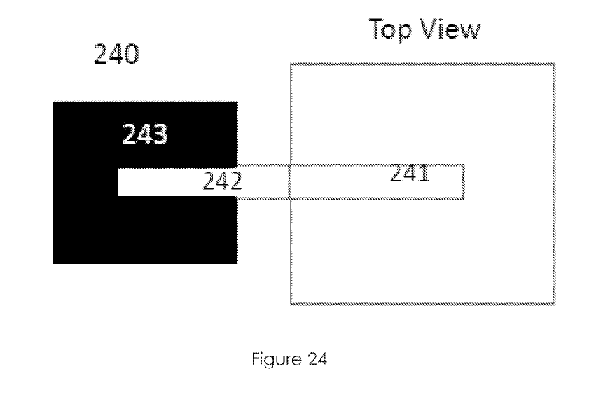

The shape of the channel may also be productively adjusted to yield any shape that is suitable for patterning, beyond the biaxially symmetric examples shown in FIGS. 18-23. FIG. 24 shows an example top view of a non-biaxially symmetric sensor channel 240, where a single channel can be conceptually divided into two subchambers 241 and 242. Subchamber 241 advantageously allows fluid to pass through the system quickly with minimal flow restriction or pressure drop; however, such large openings result in degraded signal/noise of the flow measurement as the majority of the marker may diffuse into the body of the flow, where it is not accessible to the read electrodes. By contrast, subchamber 242 will yield a higher signal/noise ratio, but serves as a significant restrictor of flow. By combining two subchambers together to make a single chamber, it becomes possible to usefully harness the advantages of each subchamber, so that the marker is detected with high signal/noise in the smaller subchamber while fluid freely passes through the larger subchamber, and where the actual flow rate is calculated based on pressure drop differential between the two chambers, which depends on their volume ratios and the fluid viscosity.

In this example, we also use the methods illustrated in FIG. 23 to show a patterned electrode 243 which is in contact with only the smaller subchamber where the measurements are made. Because the flow velocities in the two subchambers, will differ, this approach may usefully allow signal to be taken only in the smaller chamber.

I/We claim:

1. A sensor for measuring volumetric flow rate of a fluid, comprising a body comprising an inlet and an outlet and at least one flight tube there between comprising at least one marker detector disposed along said flight tube configured to detect a position of at least one marker in the fluid; and a control circuitry for determining the volumetric displacement of the fluid along the flight tube from a first known position of said marker, and at least a second position of the marker detected by said at least one detector.

2. The sensor of claim 1 further comprising a marker generator where said first know position of the marker is determined by the position of the marker generator.

3. The sensor of claim 1 further comprising a second marker detector to detect said first known position of the marker.

4. The sensor of claim 1 comprising a plurality of marker detectors for detecting multiple positions of the marker along said flight tube.

5. The sensor of claim 1 where at least one marker detector is further utilized to perform time of flight flow measurement.

6. The sensor of claim 1 where at least one marker detector is utilized to determine diffusion or dissipation of said marker.

7. The sensor of claim 1 where said marker is a local compositional variation of said fluid.

8. The sensor of claim 7 where the compositional variation is generated by a marker generator.

9. The sensor of claim 8 where the marker generator comprises electrodes configured to perform electrolysis of said fluid.

10. The sensor of claim 7 where said marker detector is at least one electrode.

11. The sensor of claim 10 where said electrode in configured to sense at least one of a change in conductivity, pH, and capacitance of the fluid.

12. The sensor of claim 1 further comprising at least one flow control device for regulating said fluid flow in at least one flight tube consisting of at least one of a valve, a flow regulator, a pressure regulator, and a pump.

13. The sensor of claim 12 where the flow control device is configured to produce a volumetric flow stroke of the fluid such that the marker position is detectable by at least one marker detector after stroke has been completed.

14. A method for sensing volumetric flow of a fluid that comprises at least one marker, by utilizing a sensor comprising a body comprising an inlet and an outlet and at least one flight tube there between comprising at least one marker detector disposed along said flight tube configured to detect a position of at least one marker in the fluid; the method comprising:
a. determining a first position of a marker from at least one of the position of the marker generator, detection of the marker by at least one marker detector, and the flow rate prior to detecting the marker by a marker detector;
b. determining a second position of a marker from at least one marker detector; and
c. calculating the volumetric flow from at least the marker displacement from said first position to the second position, and the geometry of the flight tube.

15. The method of claim 14 where said marker varies in its composition from the surrounding fluid.

16. The method of claim 14 where the marker generator performs electrolysis of the fluid.

17. The method of claim 14 where the marker detector detects the marker by sensing the variation of at least one of the conductivity, capacitance, and pH of the fluid.

18. The method of claim 14 where the sensor further comprises a flow control device configured to stop and turn on the flow, where the marker generator generates a marker in the fluid before the flow is opened.
